(19) United States
(12) Patent Application Publication
(10) Pub. No.: US 2026/0254912 A1
(43) Pub. Date: Aug. 27, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Hiroki Fuwa, Nagoya (JP); Hideaki Ueda, Nagoya (JP); Naoki Kusumoto, Nagoya (JP)

(21) Appl. No.: 19/408,361

(22) Filed: Dec. 4, 2025

(30) Foreign Application Priority Data
Dec. 5, 2024 (JP) 2024-212053
Dec. 5, 2024 (JP) 2024-212288
Dec. 13, 2024 (JP) 2024-219024

(51) Int. Cl. H04N 1/387; G06F 40/109

(52) U.S. Cl. CPC H04N 1/3875; G06F 40/109

(57) ABSTRACT

A non-transitory computer readable storage medium storing a program causing an information processing apparatus to execute procedures includes: displaying, on a display of the apparatus, an editing screen configured to receive editing of a label, the editing screen having displayed thereon a print guaranteed area of the label. The editing screen enables an object, includes an object frame, corresponding to a content to be disposed thereon. The object frame is movable toward an outside of the print guaranteed area. The program further causes the apparatus to execute for the object disposed on the editing screen: displaying, the object with a first color when the object fits in the print guaranteed area; and when at least a part of the object does not fit, displaying, the object with a second color, a third color, and a fourth color.

### REFERENCE TO RELATED APPLICATIONS

This application claims priority from Japanese Patent Application No. 2024-212053 filed on Dec. 5, 2024, Japanese Patent Application No. 2024-212288 filed on Dec. 5, 2024, and Japanese Patent Application No. 2024-219024 filed on Dec. 13, 2024. The entire contents of these priority applications are incorporated herein by reference.

### BACKGROUND ART

In a related art, a program having a label editing function is known. The related art discloses an editor program having a label editing function, and the editor program has a configuration in which a warning icon is displayed when a character frame protrudes from a print guaranteed area of a label.

When a content disposed on an editing screen protrudes from the print guaranteed area of the label, it is desirable to notify a user of the presence of such a content because a printing result which is not intended by the user may be obtained. The warning in Patent Literature 1 allows the user to know protrusion of the content, but it is difficult for the user to grasp which content protrudes from the print guaranteed area.

### SUMMARY

A non-transitory computer readable storage medium storing a program causing an information processing apparatus to execute procedures including:
executing screen display processing of displaying, on a display of the information processing apparatus, an editing screen configured to receive editing of a label, the editing screen having displayed thereon a print guaranteed area of the label, in which
the editing screen enables an object corresponding to a content to be disposed thereon, the object having an object frame indicating an outline of the object, the object frame having the content disposed therein, the object including the content being changeable in position by changing a position of the object frame through an operation via an input interface of the information processing apparatus, the object frame being movable toward an outside of the print guaranteed area,
the program further causes the information processing apparatus to execute, for the object disposed on the editing screen, display processing of:
displaying, on a display, the object with a first color when the object fits in the print guaranteed area; and
when at least a part of the object does not fit in the print guaranteed area,
displaying, on the display, the at least a part of the object with a second color,
displaying, on the display, the print guaranteed area on the editing screen with a third color, and
displaying, on the display, an area outside the print guaranteed area with a fourth color, in which
the second color is a color different from the first color, the third color, and the fourth color, and
the third color and the fourth color are different colors.

A non-transitory computer readable storage medium storing a program causing an information processing apparatus to execute procedures including:
executing screen display processing of displaying, on a display of the information processing apparatus, an editing screen configured to receive editing of a label, the editing screen having displayed thereon a print guaranteed area of the label, in which
the editing screen enables an object corresponding to a content to be disposed thereon, the object having a rectangular object frame indicating an outline of the object, the object frame having the content disposed therein, the object including the content being changeable in position by changing a position of the object frame through an operation via an input interface of the information processing apparatus, the object frame being movable toward an outside of the print guaranteed area, and
the program further causes the information processing apparatus to execute, for the object disposed on the editing screen, display processing of:
displaying, on the display, the object in a first shape when the object fits in the print guaranteed area; and
displaying, on the display, at least a part of the object in a second shape different from the first shape when the at least a part of the object does not fit in the print guaranteed area.

A method of displaying an editing screen executable by an information processing apparatus, the method causing the information processing apparatus to
execute screen display processing of displaying, on a display of the information processing apparatus, an editing screen configured to receive editing of a label, the editing screen having displayed thereon a print guaranteed area of the label, in which
the editing screen enables an object corresponding to a content to be disposed thereon, the object having an object frame indicating an outline of the object, the object frame having the content disposed therein, the object including the content being changeable in position by changing a position of the object frame through an operation via an input interface of the information processing apparatus, the object frame being movable toward an outside of the print guaranteed area,
the program further causes the information processing apparatus to execute, for the object disposed on the editing screen, display processing of:
displaying, on a display, the object with a first color when the object fits in the print guaranteed area; and
when at least a part of the object does not fit in the print guaranteed area,
displaying, on the display, the at least a part of the object with a second color,
displaying, on the display, the print guaranteed area on the editing screen with a third color, and
displaying, on the display, an area outside the print guaranteed area with a fourth color, in which
the second color is a color different from the first color, the third color, and the fourth color, and
the third color and the fourth color are different colors.

### BRIEF DESCRIPTION OF DRAWINGS

FIG. 1 is a diagram illustrating a general configuration of a personal computer provided with a label editing app.

FIG. 2 is a flowchart illustrating an example of a control procedure for label editing processing.

FIG. 3 is a diagram illustrating an example of an editing screen.

FIG. 4 is a flowchart illustrating an example of a control procedure for in-frame display processing.

FIG. 5A is a diagram illustrating a display example of an object after the in-frame display processing.

FIG. 5B is a diagram illustrating a display example of the object after the in-frame display processing.

FIG. 6 is a flowchart illustrating an example of a control procedure for the label editing processing executed by the label editing app.

FIG. 7 is a flowchart illustrating an example of a control procedure for object display processing executed by the label editing app.

FIG. 8A is a diagram illustrating a display example of the object after the object display processing.

FIG. 8B is a diagram illustrating a display example of the object after being switched to an inactive state.

FIG. 9 is a diagram illustrating a display example of the object.

FIG. 10A is a diagram illustrating a display example of an object frame of a two-dimensional barcode.

FIG. 10B is a diagram illustrating a display example of the object frame of the two-dimensional barcode.

FIG. 11 is a flowchart illustrating an example of a control procedure for character display processing.

FIG. 12 is a diagram illustrating a display example of a text object.

FIG. 13 is a diagram illustrating a display example of a text object.

FIG. 14 is a flowchart illustrating an example of a control procedure for the label editing processing executed by the label editing app.

FIG. 15 is a flowchart illustrating an example of a control procedure for the character display processing.

FIG. 16 is a diagram illustrating a display example of the text object.

FIG. 17 is a flowchart illustrating an example of a control procedure for frame display processing.

FIG. 18 is a diagram illustrating a display example of an object frame.

FIG. 19 is a diagram illustrating a display example of the object frame.

FIG. 20 is a flowchart illustrating an example of a control procedure for the label editing processing executed by the label editing app.

FIG. 21 is a diagram illustrating a display example of an object frame of a two-dimensional barcode.

### DESCRIPTION

### First Embodiment

### General Configuration of PC 1

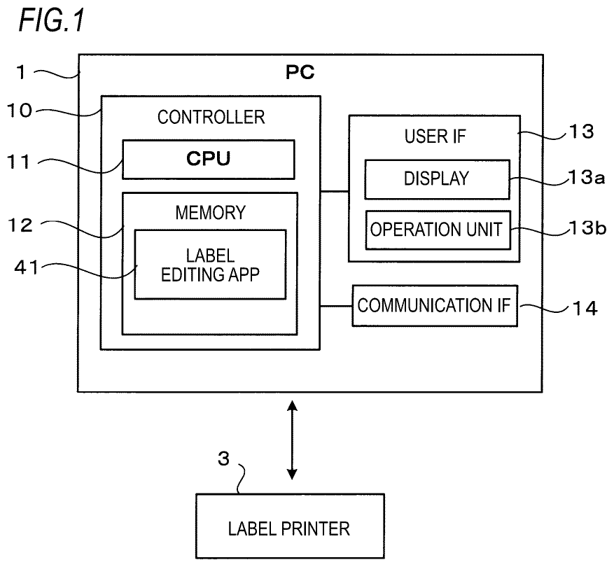

As illustrated in FIG. 1, a PC 1 includes a controller 10 including a CPU 11 and memory 12. The PC 1 also includes a user interface (hereinafter referred to as a “user IF”) 13 and a communication interface (hereinafter referred to as a “communication IF”) 14, which are electrically connected to the controller 10. The PC 1 can be communicatively connected to a label printer 3. The PC 1 is an example of an “information processing apparatus”. An example of the information processing apparatus is not limited to the PC 1, but may be a smartphone, a tablet terminal, or the like.

The CPU 11 executes various types of processing according to a program read from the memory 12 and based on an operation of a user. Note that the controller 10 in FIG. 1 is a general term for hardware and software used to control the PC 1 and does not necessarily represent a single piece of hardware actually present in the PC 1.

The memory 12 of the PC 1 of the present embodiment stores various programs including a label editing application program (hereinafter referred to as a “label editing app”) 41 and various types of data. The memory 12 is also used as a work area when various types of processing are executed.

The CPU 11 may read the label editing app 41 from a storage medium readable by the CPU 11. Examples of the storage medium readable by the CPU 11 include a CD-ROM, a DVD-ROM, and a USB memory.

The label editing app 41 is a program that displays an editing screen for editing a label on the PC 1 and edits an image of the label to be printed based on a user instruction received via the user IF 13. The label editing app 41 may have a function of receiving a print instruction via the user IF 13 and transmitting a print job based on the edited image to the label printer 3. Label editing processing for editing a label will be described later. The label editing app 41 is an example of a “program”.

The user IF 13 includes hardware that displays a screen to notify the user of information and hardware that receives an operation by the user. The user IF 13 may be configured with separate pieces of hardware for a display function and an operation function, such as a display 13a and an operation unit 13b such as a keyboard or a mouse, or may be configured with a single piece of hardware for a display function and an operation function, such as a touch panel. The operation unit 13b is an example of an “input interface”.

The communication IF 14 includes hardware for communication with external devices. Communication standards of the communication IF 14 include Ethernet (registered trademark), Wi-Fi (registered trademark), USB, and the like. The PC 1 may be provided with a plurality of communication IFs 14 supporting a plurality of communication standards. A communication method may be performed in a wired or wireless manner.

### Configuration of Label Printer 3

The label printer 3 is an apparatus that prints an image on a long-length medium to be printed serving as a label. The label printer 3 performs printing on a continuous tape-like medium to be printed having a predetermined width, conveys the medium to be printed, and ejects a printed portion of the medium to be printed outside the printer. A printing method used by the label printer 3 may be a thermal transfer method or a thermal sensitivity method.

In the present embodiment, the medium to be printed is referred to as a “tape”. In the tape, for example, a plurality of seal-like labels are attached to a mount, which is a tape-like base material, in a longitudinal direction of the tape. A label shape may be a rectangular shape, a T-shape, a circular shape, an elliptical shape, or a shape in which a square is cut into a circular shape. For example, the label printer 3 performs printing on a label while unwinding a built-in roll-like tape, and then cuts the printed label from the tape. The label printer 3 may be capable of handling a plurality of kinds of tape widths.

### Label Editing Processing

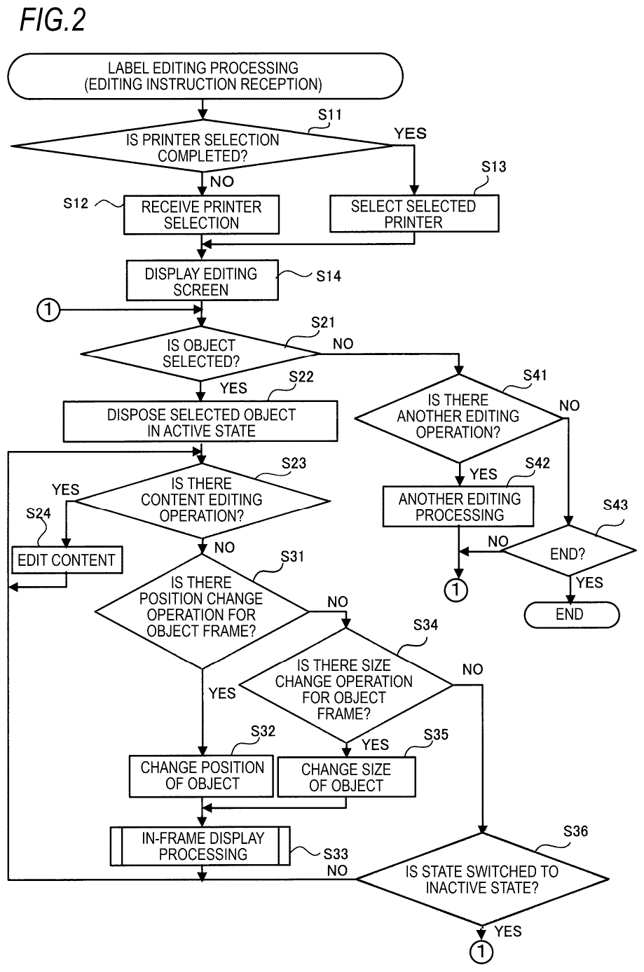

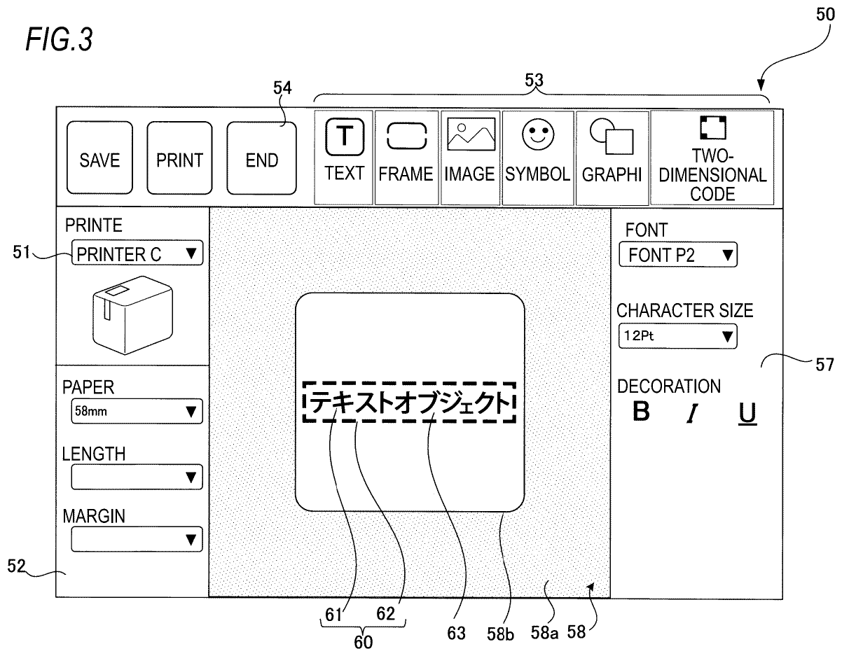

The label editing function described above will be described with reference to FIG. 2. In the PC 1, when the label editing app 41 is started and an editing instruction is received, the CPU 11 executes label editing processing illustrated in FIG. 2 by using the label editing app 41. In the label editing processing, an image to be printed on the label is edited via an editing screen 50 illustrated in FIG. 3. In the present embodiment, a case in which a text object is edited will be described as an example.

Specifically, the CPU 11 first determines whether the label printer 3 to be controlled has been selected (S11). For example, when the label printer 3 to be controlled is registered in the label editing app 41, the CPU 11 determines that the label printer 3 has been selected (S11: YES). In this case, the CPU 11 selects the selected label printer 3 (S13) and proceeds to S14. On the other hand, when the label printer 3 is not selected yet (S11: NO), the CPU 11 receives the selection of the label printer 3 (S12) and then proceeds to S14. When the label printer 3 to be controlled is selected, the CPU 11 displays the editing screen 50 illustrated in FIG. 3 on the display 13a (S14). S14 is an example of “screen display processing”.

The editing screen 50 illustrated in FIG. 3 includes a printer selection field 51, a label attribute setting area 52, an edited image display area 58, an object setting area 57, and various operation buttons.

The printer selection field 51 receives the selection of a printer to be controlled. When the printer selection field 51 is initially displayed, the label printer 3 selected in S12 or S13 is displayed in the printer selection field 51. The label attribute setting area 52 is an area in which settings related to attributes of a label are received. Attributes of a label include, for example, a width, a length, and a margin of the label. When the label attribute setting area 52 is initially displayed, tape information obtained from the printer selected in the printer selection field 51 is displayed for each setting of the label attribute setting area 52. For example, tape information for a tape currently mounted in the selected printer is displayed in the label attribute setting area 52.

The edited image display area 58 displays an image which is being edited. The edited image display area 58 includes a print guaranteed area 58b and an area outside the print guaranteed area 58a. The print guaranteed area 58b is an area that virtually represents a label and is an area in which printing of an image is guaranteed. Meanwhile, the area outside the print guaranteed area 58a is an area that virtually represents the outside of the label and is an area in which an image cannot be printed on the label. Meanwhile, the area outside the print guaranteed area 58a is an area outside the label and is an area in which an image cannot be printed on the label. In the initial display of the edited image display area 58, the print guaranteed area 58b is displayed based on the tape information set in the label attribute setting area 52. For example, in FIG. 3, the print guaranteed area 58b virtually illustrating the label in a case where a tape including a label, the four corners of which is cut into a circular shape, is set in the tape information of the label attribute setting area 52 is displayed in the edited image display area 58.

In order to enable the user to edit an image while visualizing a printed result, the print guaranteed area 58b of the edited image display area 58 is displayed with the same color as a base color (for example, white) of the label, and the area outside the print guaranteed area 58a is displayed with a color (for example, light gray) different from the base color of the label. The color of the area outside the print guaranteed area 58a is preferably different from the color of a content to be printed on the label so as to enable the user to grasp a content protruding from the print guaranteed area 58b. The color of the print guaranteed area 58b is an example of a “third color”, and the color of the area outside the print guaranteed area 58a is an example of a “fourth color”.

One or more objects can be disposed in the edited image display area 58. An object is formed of a rectangular object frame indicating an outline of the object and a content disposed inside the object frame. The position of the object can be changed by changing the position of the object frame by operation via the operation unit 13b. Further, the size of the object can be changed by changing the size of the object frame by operation via the operation unit 13b. A plurality of types of objects that can be disposed inside the edited image display area 58 are prepared in advance in the label editing app 41. The types of the object include, for example, a text object, a graphic object, and a two-dimensional code object. A character string, a graphic, and a two-dimensional code included in the respective objects of a text object, a graphic object, and a two-dimensional code object are examples of a “content”. Note that, although FIG. 3 illustrates an example of the editing screen 50 in a state in which a text object 60 is disposed in the edited image display area 58, no object is disposed in the print guaranteed area 58b in the initial display of the editing screen 50.

After setting the initial display of the editing screen 50, the CPU 11 determines whether an object has been selected (S21). Object types prepared in advance are displayed in an object selection field 53 and can be selected by the label editing app 41. The label editing app 41 can select an object to be disposed on the label via the object selection field 53.

For example, when the text object is selected in the object selection field 53 (S21: YES), the CPU 11 disposes the text object 60 in the edited image display area 58 in an active state (S22). An active state of an object is a state in which the object is editable. The object displayed in the edited image display area 58 can be switched between an active state and an inactive state by operation of the operation unit 13b. For example, the CPU 11 of the present embodiment disposes the text object 60 in the active state on the display 13a by displaying an object frame 62 of the text object 60, the content of which is a character string 61, in the print guaranteed area 58b. The object frame 62 of the initially displayed text object 60 is disposed in the print guaranteed area 58b so that all four sides of the object frame fit in the print guaranteed area 58b.

In the text object 60 of the present embodiment, the background color of an area 63 surrounded by the object frame 62 is initially set to “100%” in transparency or to “none” in paint-out. As a result, in the text object 60, the color of the print guaranteed area 58b drawn on the back surface of the text object 60 and the color of the area outside the print guaranteed area 58a are displayed inside the object frame 62. The background color of the text object 60 may be initially set to a default color such as white, or to the color of the print guaranteed area 58b, that is, the same color as the base color of the label. The background color of the text object 60 may be changeable in response to operation of the operation unit 13b.

A character string is not input in the initially displayed text object 60. Note that a character string as a sample may be input in advance in the text object 60. In response to the selection of the text object 60, the CPU 11 displays attributes and setting values that can be set for the text object 60 in the object setting area 57 of the editing screen 50. Attributes that can be set for the text object 60 include, for example, a font, a character size, a character color, a background color, and a character decoration (bold, italic, underline, and the like).

When the selected text object 60 is displayed in the active state, the CPU 11 determines whether there is an operation of editing the character string 61, which is the content of the text object 60 (S23). When there is the operation of editing the character string 61 (S23: YES), the CPU 11 edits the character string 61 based on an editing operation (S24). For example, upon receiving an operation of inputting the character string 61 using the operation unit 13b, the CPU 11 displays the input character string 61 inside the object frame 62. The character string 61 is displayed with a color to be printed on the label. Furthermore, for example, when the character size is changed in the object setting area 57, the CPU 11 changes the character size of the character string 61 displayed in the object frame 62 to the changed character size. After editing the character string 61, the CPU 11 returns to S23 and waits for the next operation on the text object 60.

When there is no operation of editing the character string 61 (S23: NO), the CPU 11 determines whether there is an operation of changing the position of the object frame 62 (S31). For example, when a drag-and-drop operation is performed on the text object 60 using the operation unit 13b, the CPU 11 determines that there is an operation of changing the position of the object frame 62.

When there is the operation of changing the position of the object frame 62 (S31: YES), the CPU 11 changes the position of the text object 60 including the character string 61 from a drag start position to a drag end position, that is, a drop position (S32). The entirety of the area 63 surrounded by the object frame 62 of the text object 60, the position of which has been changed, may be present in the print guaranteed area 58b, or a part or entirety thereof may be present outside the print guaranteed area 58b. That is, the text object 60 can be moved to the outside of the print guaranteed area 58b. In this case, at least a part of the text object 60 is present in the area outside the print guaranteed area 58a. Further, the position of the text object 60 can be changed even if the character string 61 is not input in the text object.

When the position of the text object 60 is changed, the CPU 11 executes in-frame display processing (S33). The in-frame display processing is processing of displaying a portion of the area 63 surrounded by the object frame 62, which is not present in the print guaranteed area 58b, on the display 13a with a color different from a color of a portion of the area, which is present in the print guaranteed area 58b. The in-frame display processing will be described later. After the in-frame display processing is executed, the CPU 11 returns to S23 and waits for the next operation on the text object 60.

When there is no operation of changing the position of the object frame 62 (S31: NO), the CPU 11 determines whether there is an operation of changing the size of the object frame 62 (S34). For example, when a drag operation is performed on one of the four sides of the object frame 62 or on one of the four corners of the object frame 62 using the operation unit 13b, the CPU 11 determines that there is the operation of changing the size of the object frame 62.

When there is the operation of changing the size of the object frame 62 (S34: YES), the CPU 11 changes the size of the corresponding text object 60 (S35). In the text object 60 of which the size is changed, the entirety of the area 63 surrounded by the object frame 62 may be present in the print guaranteed area 58b, or a part or entirety of the area 63 may be present outside the print guaranteed area 58b. That is, the text object 60 may be expanded to the outside of the print guaranteed area 58b. In this case, at least a part of the text object 60 is present in the area outside the print guaranteed area 58a. Further, the size of the text object 60 can be changed even if the character string 61 is not input in the text object.

When the size of the text object 60 is changed, the CPU 11 executes the in-frame display processing (S33). The in-frame display processing will be described later. After the in-frame display processing is executed, the CPU 11 returns to S23 and waits for the next operation on the text object 60.

When there is no operation of changing the size of the object frame 62 (S34: NO), the CPU 11 determines whether the text object 60 being edited is switched from an active state to an inactive state (S36). When the text object 60 cannot be switched to the inactive state (S36: NO), the CPU 11 returns to S23 and waits for the next operation on the text object 60.

On the other hand, when another object is selected in the object selection field 53 of the editing screen 50, the CPU 11 switches the text object 60 being edited from the active state to the inactive state. In the text object 60 switched to the inactive state, the object frame 62 becomes hidden. For example, when receiving a print instruction or a save instruction via an operation button of the editing screen 50, the CPU 11 changes the state of the text object 60 to the inactive state.

When the text object 60 is switched to the inactive state (S36: YES), the CPU 11 returns to S21. For example, when a two-dimensional code object is selected in the object selection field 53 of the editing screen 50 (S21: YES), the CPU 11 executes processing of S22 and thereafter with respect to the selected two-dimensional code object.

For example, when there is no operation of selecting an object (S21: NO), the CPU 11 determines whether there is another editing operation (S41). When there is another editing operation (S41: YES), the CPU 11 executes the another editing processing (S42). For example, when a tape to be used is changed in the label attribute setting area 52 of the editing screen 50 from a tape in which a rectangular label having rounded corners is attached to a mount to a tape in which a T-shaped label is attached to a mount, the CPU 11 sets the shape of the print guaranteed area 58b to a T-shape. At this time, the CPU 11 does not change the position or the size of the object. Further, for example, upon receiving a print instruction via the editing screen 50, the CPU 11 generates print data based on the edited image and transmits a print job including the generated print data to the label printer 3. Additionally, for example, upon receiving a save instruction via the editing screen 50, the CPU 11 generates a file that stores therein a content of the edited image and saves the file in a predetermined location. When performing another editing operation, the CPU 11 returns to S21 and waits for the next operation.

When there is no another editing operation (S41: NO), the CPU 11 determines whether to end the label editing processing (S43). When an end button 54 of the editing screen 50 is not operated, the CPU 11 determines not to end the label editing processing. When the editing of the label is not ended (S43: NO), the CPU 11 returns to S21 and waits for the next operation. On the other hand, when the end button 54 is operated, the CPU 11 determines to end the label editing processing (S43: YES) and ends the label editing processing illustrated in FIG. 2.

### In-Frame Display Processing

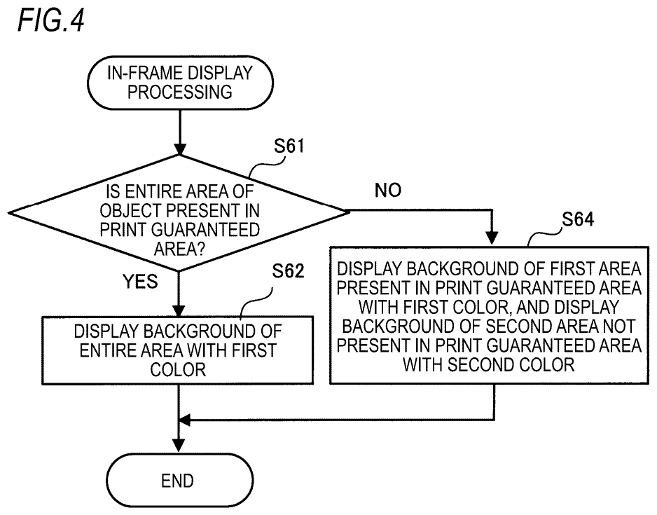

The above-mentioned in-frame display processing will be described with reference to FIG. 4. For example, when the position or the size of an object is changed, the CPU 11 executes the in-frame display processing illustrated in FIG. 4 using the label editing app 41. Here, as an example, a description will be given as to a case in which the position or the size of the text object 60 is changed.

Specifically, the CPU 11 determines whether the entirety of the area 63 surrounded by the object frame 62 is present in the print guaranteed area 58b (S61). For example, as illustrated in FIG. 3, when the object frame 62 fits in the print guaranteed area 58b, that is, when the area 63 surrounded by the object frame 62 fits in the print guaranteed area 58b, the CPU 11 determines that the entirety of the area 63 is present in the print guaranteed area 58b. When the entirety of the area 63 is present in the print guaranteed area 58b (S61: YES), the CPU 11 displays the background of the entirety of the area 63 with a first color (S62) and ends the in-frame display processing. In the present embodiment, the first color is a color conforming to the attribute of the text object 60. In other words, nothing changes except the position or the size of the character string 61 and the object frame 62 of the text object 60.

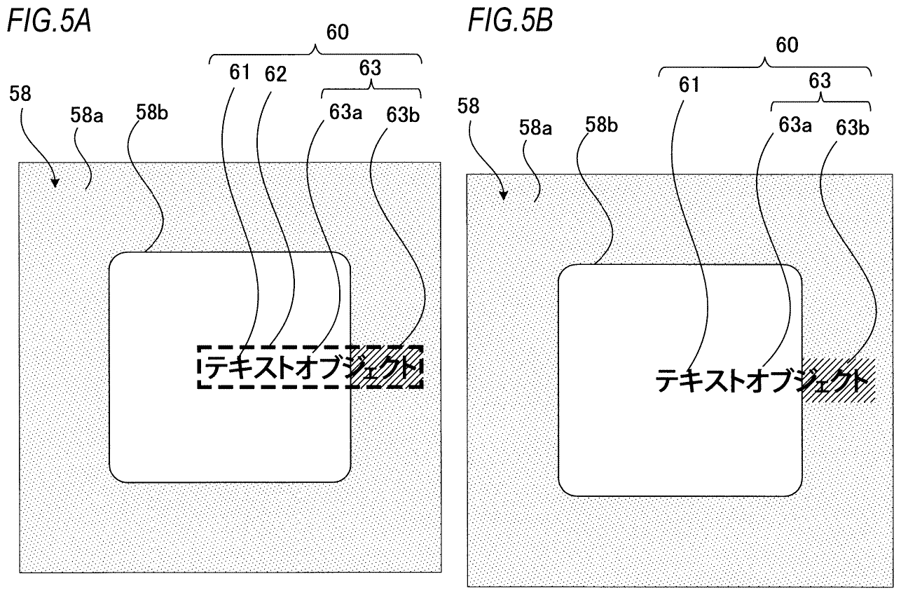

On the other hand, as illustrated in FIG. 5A, when the area 63 surrounded by the object frame 62 protrudes from the print guaranteed area 58b, the CPU 11 determines that the entirety of the area 63 is not present in the print guaranteed area 58b. When the entirety of the area 63 is not present in the print guaranteed area 58b (S61: NO), the CPU 11 displays, on the display 13a, the background of a first area 63a of the area 63, which is present in the print guaranteed area 58b, with the first color, displays, on the display 13a, the background of a second area 63b of the area, which is not present in the print guaranteed area 58b, with a second color (S64), and ends the in-frame display processing.

Desirably, the second color is a color different from the first color displayed in the first area 63a, the color of the print guaranteed area 58b, that is, the base color of the label, and the color of the area outside the print guaranteed area 58a, that is, the background color of the edited image display area 58. The reason for this is that, since the second area 63b is displayed differently from the print guaranteed area 58b and the area outside the print guaranteed area 58a, it becomes easier for the user to find the text object 60 having the second area 63b. Furthermore, when the character string 61 is a single color, the second color is preferably different from the color of the character string 61. Accordingly, it is possible for the user to grasp the entirety of the character string 61, including a portion not to be printed.

Note that, in the in-frame display processing, the background color of the area 63 is displayed based on the area 63 surrounded by the object frame 62 and the print guaranteed area 58 b. Accordingly, even if the character string 61 (content) corresponding to the text object 60 (object) does not protrude from the print guaranteed area 58b, when the margin of the text object 60 protrudes from the print guaranteed area 58b, the protruding portion is displayed with the second color as the second area 63b.

In the case of the text object 60, when the number of characters is small, a margin is so long that it may be difficult for the user to notice the margin protruding from the print guaranteed area 58b. However, when the area 63 surrounded by the object frame 62 of the text object 60 protrudes from the print guaranteed area 58b, through the label editing app 41 of the present embodiment, the protruding second area 63b is prominently displayed with a different color from that of the first area 63a that does not protrude from the print guaranteed area 58b. As a result, it is possible to expect the user to correct the text object 60 such that the margin is reduced.

Furthermore, in the in-frame display processing, even if no character string 61 is input in the text object 60, when the area 63 surrounded by the object frame 62 protrudes from the print guaranteed area 58b, the protruding second area 63b is displayed with a different color from that of the first area 63a that does not protrude from the print guaranteed area. Therefore, for example, the user can adjust the layout of an object in which a content is not displayed so as to prevent the object from protruding from the print guaranteed area 58b, which makes it easier to edit the label.

Here, the label editing app 41 of the first embodiment does not display the object frame 62 of the text object 60 when the text object 60 is switched from the active state to the inactive state. The background color of the text object 60 in the inactive state may return to a color according to the attribute, or, as illustrated in FIG. 5B, the background of the second area 63b may be displayed with the second color. When the second area 63b is displayed with the second color, even if the user performs another editing operation without correcting the text object 60 protruding from the print guaranteed area 58b, the second area 63b of the text object 60 continues to be displayed with the second color on the editing screen 50, thereby enabling the user to notice protrusion of the text object 60. Furthermore, since the object frame 62 of an object not to be edited is not displayed on the editing screen 50, the label editing app 41 can notify the user of the protrusion of the object while displaying an image to be printed on the label in the print guaranteed area 58b according to a print image.

As described above, through the label editing app 41 of the first embodiment, the PC 1 displays, at a timing when the position or the size of the object frame 62 is changed, the background of the second area 63b of the area 63 surrounded by the object frame 62, which is not present in the print guaranteed area 58b, with the second color different from the first color used to display the background of the first area 63a of the area surrounded by the object frame, which is present in the print guaranteed area 58b. As a result, a portion of the text object 60 disposed on the editing screen 50, which protrudes from the print guaranteed area 58b, becomes more prominent. Therefore, it is easy for the user to grasp protrusion from the print guaranteed area 58b of the text object 60 displayed on the editing screen 50. Furthermore, since it is easy for the user to grasp how the text object 60 protrudes from the print guaranteed area 58b, correction can be performed easily.

### Second Embodiment

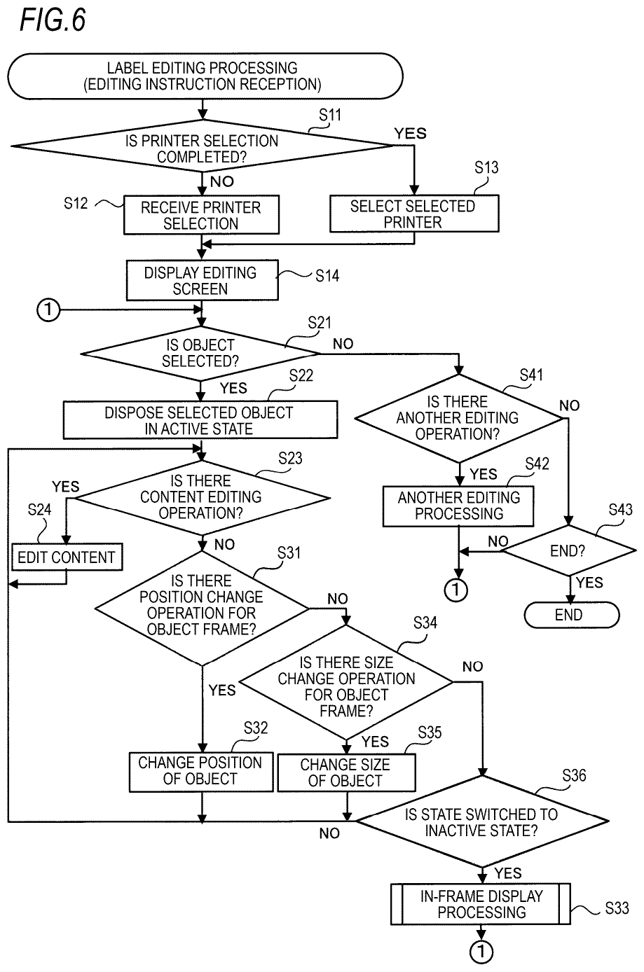

Next, the label editing app 41 of a second embodiment will be described. As illustrated in FIG. 6, the label editing app 41 of the second embodiment executes the in-frame display processing at a timing when an object is switched from an active state to an inactive state. This point is different from the first embodiment in which the in-frame display processing is executed at a timing when the position or the size of the object is changed. In the second embodiment, only configuration and processing different from those of the first embodiment will be described, the same configuration and processing as those of the first embodiment will be denoted by the same reference numerals as those of the first embodiment, and redundant description thereof will be appropriately omitted.

As illustrated in FIG. 6, for example, when the position or the size of the text object 60 is changed in response to a change in the position or the size of the object frame 62 (S32, S35), the CPU 11 returns to S23 without executing the in-frame display processing.

When the text object 60 being edited is switched from an active state to an inactive state (S36: YES), the CPU 11 executes the in-frame display processing (S33) and returns to S21. For example, as illustrated in FIG. 5B, regarding the text object 60 having the second area 63b, the CPU 11 does not display the object frame 62 while displaying the second area 63b with a color different from the color of the first area 63a. As a result, the user can grasp the protrusion of the text object 60 while grasping that the text object 60 is no longer an object to be edited.

Note that, when the text object 60 in the inactive state protrudes from the print guaranteed area 58b, the object frame 62 may be left as it is. By leaving the object frame 62 as it is, the user can more easily grasp and correct the protruding portion of the text object 60, as compared with a case in which the object frame 62 is not displayed.

In this manner, the PC 1 executing the label editing app 41 of the second embodiment changes the background color of the second area 63b that is not present in the print guaranteed area 58b at a timing when the text object enters the inactive state, or at a timing when the object is switched from the active state to the inactive state. As a result, the label editing app 41 of the second embodiment can further reduce a processing load on the PC 1 when an object is edited, as compared with a case in which the background color of the second area 63b is changed each time the text object 60 is edited.

However, by changing the background color of the second area 63b that is not preset in the print guaranteed area 58b at a timing when the position or the size of the object is changed, as in the label editing app 41 of the first embodiment, the PC 1 enables the user to immediately grasp whether the position or the size of the object is appropriate, as compared with a case in which the background color of the second area 63b is changed at a timing when the object enters the inactive state.

### Third Embodiment

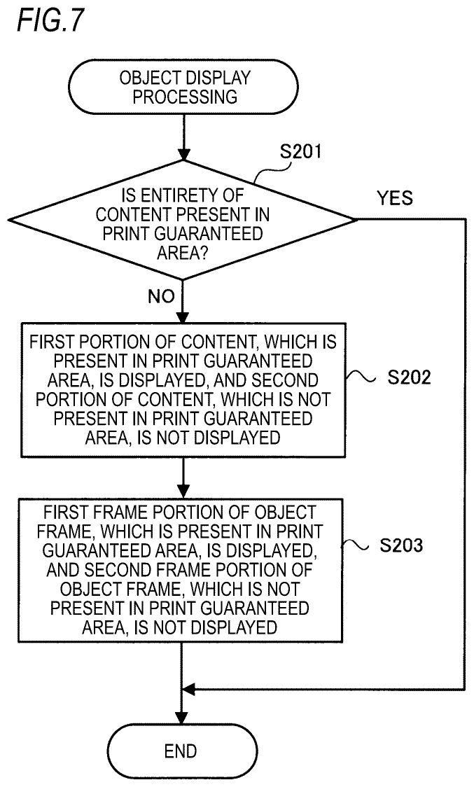

Next, the label editing app 41 of a third embodiment will be described. The label editing app 41 of the third embodiment is different from the label editing app 41 of the first embodiment in that object display processing illustrated in FIG. 7 is executed instead of the in-frame display processing indicated in S33 of FIG. 2. In the third embodiment, only configuration and processing different from those of the first embodiment will be described, the same configuration and processing as those of the first embodiment will be denoted by the same reference numerals as those of the first embodiment, and redundant description thereof will be appropriately omitted.

For example, when the position or the size of an object to be edited is changed, the CPU 11 executes the object display processing illustrated in FIG. 7 using the label editing app 41 of the third embodiment. In the present embodiment, a case in which the object display processing is executed on the text object 60 will be described as an example.

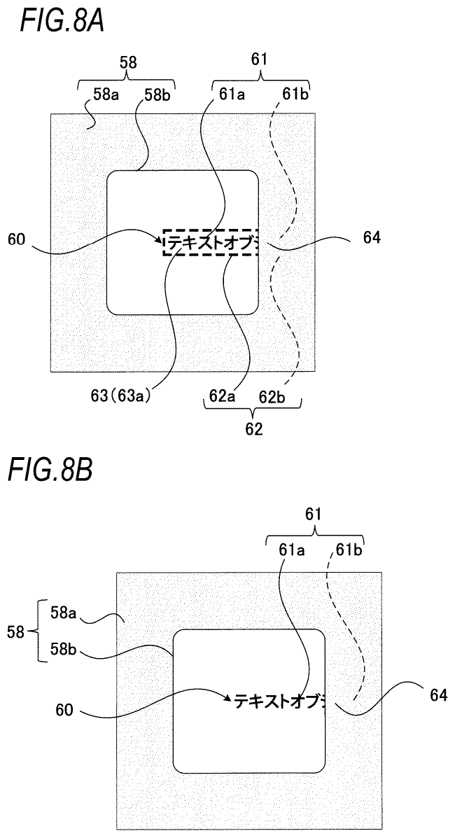

The CPU 11 determines whether the entirety of a content of an object, the position or the size of which has been changed, is present in the print guaranteed area 58b (S201). When a part of the colored portion of the content is not present in the print guaranteed area 58b, the CPU 11 determines that the entirety of the content is not present in the print guaranteed area 58b. For example, when the entirety of “ [symbol] ”, which is the character string 61 forming the text object 60, is not present in the print guaranteed area 58b (S201: NO), as illustrated in FIG. 8A, the CPU 11 displays a first portion 61a of the character string 61 of “ [symbol] [symbol] ”, which is present in the print guaranteed area 58b, on the display 13a, and does not display a second portion 61b of the character string, which is not present in the print guaranteed area 58b, on the display 13a (S202). S202 is an example of “content display processing”.

As indicated in “ [symbol] ” of “ [symbol] ” forming the character string 61, the CPU 11 does not hide the character string 61 on a character-by-character basis, but hides a portion of the character, which is not present in the print guaranteed area 58b, even through the portion is a part of the character. That is, the CPU 11 does not display the second portion 61b of the character string 61 as in the print result. Accordingly, the user can grasp, on the editing screen 50, how the character string 61 is not printed on the label.

The label editing app 41 of the present embodiment uses a mask 64 to hide the second portion 61b. Specifically, the CPU 11 displays the character string 61 on the display 13a in a state in which the character string protrudes from the print guaranteed area 58b in response to a change in the position or the size of the text object 60. The CPU 11 does not apply the mask 64 to the first portion 61a of the character string 61, which is present in the print guaranteed area 58b, and applies the mask 64 to the second portion 61b of the character string, which is not present in the print guaranteed area 58b. As a result, the second portion 61b of the character string 61 is not displayed on the display 13a, thereby making it easier for the user to grasp a print image. The CPU 11 displays the mask 64 with the same color as that of the area outside the print guaranteed area 58a, thereby making it much easier for the user to grasp the print image.

When the second portion 61b of the character string 61, which is not present in the print guaranteed area 58b, is not displayed, as illustrated in FIG. 8A, the CPU 11 displays, on the display 13a, a first frame portion 62a of the object frame 62 of the text object 60, which is present in the print guaranteed area 58b, and does not display, on the display 13a, a second frame portion 62b of the object frame, which is not present in the print guaranteed area 58b (S203). S203 is an example of “second object frame display processing”.

In the present embodiment, the CPU 11 applies the mask 64 to the second frame portion 62b of the object frame 62, thereby hiding the second frame portion 62b. Regarding a portion of the text object 60, which protrudes from the print guaranteed area 58b, the character string 61 and the object frame 62 are not displayed, thereby enabling the user to more easily grasp the print image of the label. After hiding the second frame portion 62b, the CPU 11 ends the object display processing.

Note that, when the entirety of the character string 61 is present in the print guaranteed area 58b (S201: YES), the CPU 11 skips S202 and S203 and ends the object display processing. That is, the CPU 11 displays the text object 60 in the print guaranteed area 58b without omitting the character string 61 and the object frame 62.

When the CPU 11 switches the text object 60 from an active state to an inactive state after the object display processing is completed, the object frame 62 is not displayed, as illustrated in FIG. 8B. Even if the object frame 62 is not displayed, the second portion 61b of the character string 61 is not displayed, thereby enabling the user to notice the character string 61 protruding from the print guaranteed area 58b.

Note that, when the text object 60 enters the inactive state while protruding from the print guaranteed area 58b, the object frame 62 displayed in S203 may be left as it is. Leaving the object frame 62 as it is makes it easier for the user to notice the character string 61 protruding from the print guaranteed area 58b than a case in which the object frame 62 is not displayed.

As described above, the PC 1 executing the label editing app 41 of the third embodiment does not display, for example, the second portion 61b of the character string 61 serving as a content displayed in the text object, which is not present in the print guaranteed area 58b, at a timing when the position or the size of the object frame 62 is changed. As a result, on the editing screen 50, the text object 60 protruding from the print guaranteed area 58b is displayed as if a part of the character string 61 is missing. Therefore, it is easy for the user to grasp protrusion of the text object 60 displayed on the editing screen 50 from the print guaranteed area 58b. Furthermore, since a portion protruding from the print guaranteed area 58b is not displayed, the user can easily grasp the print image.

Note that the embodiments disclosed in the present specification are only examples and do not limit the present invention at all. Therefore, it is obvious that the technology disclosed in the present specification can be improved and modified in various ways without departing from the gist thereof.

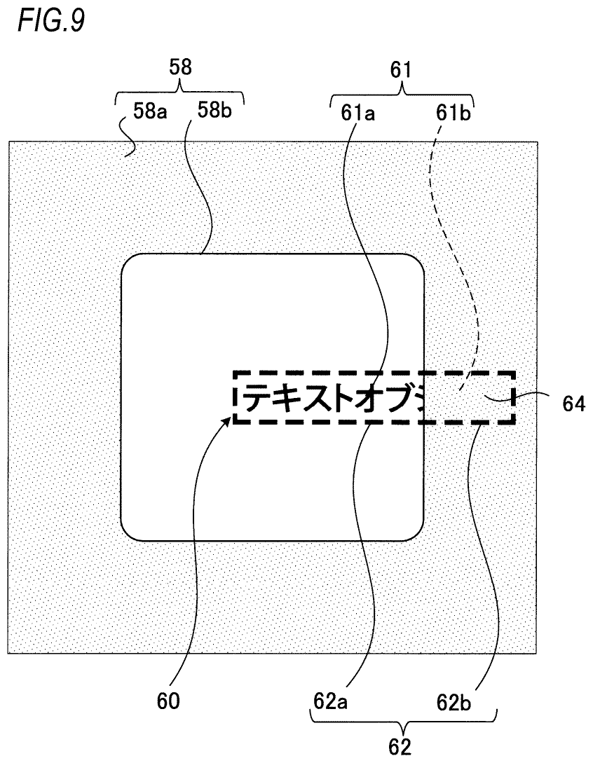

For example, S203 in FIG. 7 may be frame display processing that displays both the first frame portion 62a and the second frame portion 62b of the object frame 62. The frame display processing that displays the first frame portion 62a and the second frame portion 62b is an example of “first object frame display processing”. Note that the “first object frame display processing” may be executed by omitting S203 in FIG. 7. As illustrated in FIG. 9, by displaying the object frame 62 including the second frame portion 62b on the display 13a, the user can more easily recognize the presence of a protruding portion of an object, as compared with a case in which the second frame portion 62b is not displayed, as illustrated in FIG. 8A.

For example, an object protruding from the print guaranteed area 58b may be an object other than the text object 60, such as a two-dimensional code object or a graphic object. Examples of the two-dimensional code include a barcode and a QR code (registered trademark).

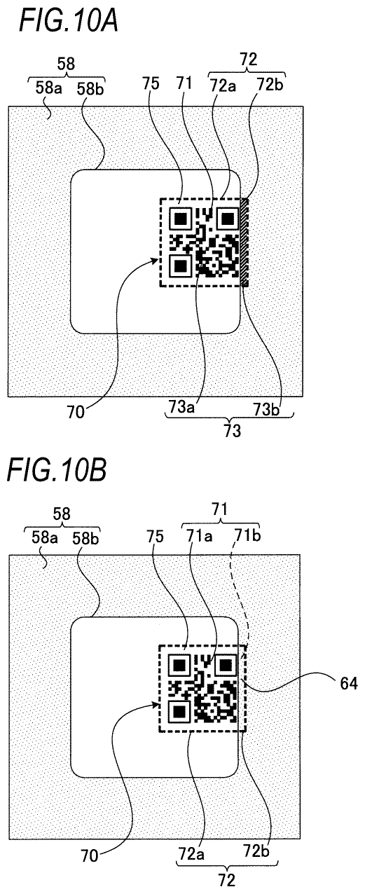

For example, as illustrated in FIGS. 10A and 10B, a two-dimensional code object 70 requires a margin 75 to distinguish the two-dimensional code object from other designs. When the margin 75 protrudes from the print guaranteed area 58b and the entirety of a two-dimensional code is not printed on the label, the two-dimensional code may not function as a two-dimensional code. Therefore, as illustrated in FIG. 10A, the label editing app 41 also displays, in a prominent manner, a second area 73b of an area 73 surrounded by an object frame 72 of the two-dimensional code object 70, which is not present in the print guaranteed area 58b, with a color different from a color of a first area 73a present in the print guaranteed area 58b, so that correction by the user can be expected.

Furthermore, as illustrated in FIG. 10B, the label editing app 41 displays a first portion 71a of a two-dimensional code 71 serving as a content of the two-dimensional code object 70, which is present in the print guaranteed area 58b, and does not display a second portion 71b of the two-dimensional code 71, which is not present in the print guaranteed area 58b, thereby making it easier for the user to grasp protrusion of the two-dimensional code 71, and furthermore, making it easier for the user to grasp a print image in which the two-dimensional code is missing. Note that, in the two-dimensional code object 70, a first frame portion 72a of the object frame 72, which is present in the print guaranteed area 58b, and a second frame portion 72b of the object frame, which is not present in the print guaranteed area 58b, are displayed on the display 13a, thereby making it easier for the user to correct the two-dimensional code object 70 protruding from the print guaranteed area 58b so that the margin 75 is disposed in the print guaranteed area 58b.

For example, the second area 63b of the area 63 surrounded by the object frame 62, which does not fit in the print guaranteed area 58b, may be the same color as the color of the print guaranteed area 58b or the color of the area outside the print guaranteed area 58a. However, using different colors makes a portion of the object, protruding from the print guaranteed area 58b, more prominent, thereby making it easier for the user to notice the protrusion of the object.

For example, in the first embodiment, when the object enters the inactive state, the background of the second area may not be displayed with the second color or may remain displayed with the second color.

For example, a timing of changing the display color of the second area or a timing of not displaying the second portion of the content may be determined by either a change in the position of the object or a change in the size of the object frame. However, by changing the display color of the second area and changing the display color of the second portion of the content at both the timing of changing the position and the timing of changing the size, the display of the object is more appropriately switched each time the object is changed, thereby making it easier for the user to notice and correct protrusion of the object.

For example, in the embodiments, the in-frame display processing and the object display processing may be executed when the label attributes are changed in the label attribute setting area 52 of the editing screen 50. For example, a tape to be used is changed in the label attribute setting area 52 from a tape in which a rectangular label having rounded corners is attached to a mount to a tape in which a T-shaped label is attached to a mount, so that the shape of the print guaranteed area 58b is changed to a T-shape (S42 in FIG. 6). In this case, the area 63 of the text object 60, which fits in the print guaranteed area 58b before the change, may protrude from the T-shaped print guaranteed area after the change. Therefore, when the label attributes are changed, the color of the second area of the object, which protrudes from the print guaranteed area 58b after the change, is changed in a prominent manner, or the second area is made hidden, so that correction by the user can be expected.

For example, in the third embodiment, after the entirety of a content is displayed, the mask 64 is applied to a portion of the content, which protrudes from the print guaranteed area 58b, thereby hiding the protruding portion of the content. For example, when the position or the size of an object is changed, a procedure of hiding a protruding portion of a content may be, from the beginning, a procedure of displaying, on the display 13a, a content, the protruding portion of which from the print guaranteed area 58b is not displayed.

The object may include a first shape and a second shape. The first shape may be a first part of the object when the object fits in the print guaranteed area. The second shape may be a second part of the object when the object does not fit in the print guaranteed area. The second shape includes not displaying the second part of the object. The second shape includes blinking the all sides surround the second part of the object. The second shape includes changing font of the second part of the object different from font of the first part of the object.

### Label Editing Processing

The label editing function described above will be described with reference to FIG. 2. In the PC 1, when the label editing app 41 is started and an editing instruction is received, the CPU 11 executes label editing processing illustrated in FIG. 2 by using the label editing app 41. In the label editing processing, an image to be printed on the label is edited via an editing screen 50 illustrated in FIG. 3.

Specifically, the CPU 11 first determines whether the label printer 3 to be controlled has been selected (S11). For example, when the label printer 3 to be controlled is registered in the label editing app 41, the CPU 11 determines that the label printer 3 has been selected (S11: YES). In this case, the CPU 11 selects the selected label printer 3 (S13) and proceeds to S14. On the other hand, when the label printer 3 is not selected yet (S11: NO), the CPU 11 receives the selection of the label printer 3 (S12) and then proceeds to S14. When the label printer 3 to be controlled is selected, the CPU 11 displays the editing screen 50 illustrated in FIG. 3 on the display 13a (S14). S14 is an example of “screen display processing”.

The editing screen 50 illustrated in FIG. 3 includes a printer selection field 51, a label attribute setting area 52, an edited image display area 58, an object setting area 57, and various operation buttons.

The printer selection field 51 receives the selection of a printer to be controlled. When the printer selection field 51 is initially displayed, the label printer 3 selected in S12 or S13 is displayed in the printer selection field 51. The label attribute setting area 52 is an area in which settings related to attributes of a label are received. Attributes of a label include, for example, a width, a length, and a margin of the label. When the label attribute setting area 52 is initially displayed, tape information obtained from the printer selected in the printer selection field 51 is displayed for each item of the label attribute setting area 52. For example, tape information for a tape currently mounted in the selected printer is displayed in the label attribute setting area 52.

The edited image display area 58 displays an image which is being edited. The edited image display area 58 includes a print guaranteed area 58b and an area outside the print guaranteed area 58a. The print guaranteed area 58b is an area that virtually represents a label and is an area in which printing of an image is guaranteed. Meanwhile, the area outside the print guaranteed area 58a is an area that virtually represents the outside of the label and is an area in which an image cannot be printed on the label. In the initial display of the edited image display area 58, the print guaranteed area 58b is displayed based on the tape information set in the label attribute setting area 52. For example, in FIG. 3, the print guaranteed area 58b virtually illustrating the label in a case where a tape including a label, the square of which is cut into a circular shape, is set in the tape information of the label attribute setting area 52 is displayed in the edited image display area 58.

In order to enable the user to edit an image while visualizing a printed result, the print guaranteed area 58b of the edited image display area 58 is displayed with the same color as a base color (for example, white) of the label, and the area outside the print guaranteed area 58a is displayed with a color (for example, light gray) different from the base color of the label. The color of the area outside the print guaranteed area 58a is preferably different from the color of a content to be printed on the label so as to enable the user to grasp a content protruding from the print guaranteed area 58b. The color of the print guaranteed area 58b is an example of a “third color”, and the color of the area outside the print guaranteed area 58a is an example of a “fourth color”.

One or more objects can be disposed in the edited image display area 58. An object is formed of a rectangular object frame indicating an outline of the object and a content disposed inside the object frame. The position of the object can be changed by changing the position of the object frame by operation via the operation unit 13b. Further, the size of the object can be changed by changing the size of the object frame by operation via the operation unit 13b. A plurality of types of objects that can be disposed inside the edited image display area 58 are prepared in advance in the label editing app 41. The types of the object include, for example, a text object, a graphic object, and a two-dimensional code object. A character string, a graphic, and a two-dimensional code included in the respective objects of a text object, a graphic object, and a two-dimensional code object are examples of a “content”. Note that, although FIG. 3 illustrates an example of the editing screen 50 in a state in which a text object 60 is disposed in the edited image display area 58, no object is disposed in the print guaranteed area 58b in the initial display of the editing screen 50.

After setting the initial display of the editing screen 50, the CPU 11 determines whether an object has been selected (S21). Object types prepared in advance are displayed in an object selection field 53 and can be selected by the label editing app 41. The label editing app 41 can select an object to be disposed on the label via the object selection field 53.

For example, when the text object is selected in the object selection field 53 (S21: YES), the CPU 11 disposes the text object 60 in the edited image display area 58 in an active state (S22). An active state of an object is a state in which the object is editable. The object displayed in the edited image display area 58 can be switched between an active state and an inactive state by operation of the operation unit 13b. For example, the CPU 11 of the present embodiment disposes the text object 60 in the active state on the display 13a by displaying an object frame 62 of the text object 60, the content of which is a character string 61, in the print guaranteed area 58b. The object frame 62 of the initially displayed text object 60 is disposed in the print guaranteed area 58b so that all four sides of the object frame fit in the print guaranteed area 58b.

In the text object 60 of the present embodiment, the background color of an area 63 surrounded by the object frame 62 is initially set to “100%” in transparency or to “none” in paint-out. As a result, in the text object 60, the color of the print guaranteed area 58b drawn on the back surface of the text object 60 and the color of the area outside the print guaranteed area 58a are displayed inside the object frame 62. The background color of the text object 60 can be changed by the user. The object frame 62 is displayed with a default color (for example, black). The object frame 62 may be displayed with a frame color designated by the user or with a frame color automatically selected by the label editing app 41.

A character string is not input in the initially displayed text object 60. Note that a character string as a sample may be input in advance in the text object 60. In response to the selection of the text object 60, the CPU 11 displays attributes and setting values that can be set for the text object 60 in the object setting area 57 of the editing screen 50. Attributes that can be set for the text object 60 include, for example, a font, a character size, a character color, a background color, and a character decoration (bold, italic, underline, and the like).

When the selected text object 60 is displayed in the active state, the CPU 11 determines whether there is an editing operation for the selected text object 60 (S23). When there is no editing operation for the selected text object 60 (S23: NO), the CPU 11 proceeds to S26 to be described later. When there is the editing operation for the selected text object 60 (S23: YES), the CPU 11 determines whether the operation is an operation of adding a character (S24). When one character is input via the operation of the operation unit 13b, the CPU 11 determines that there is the operation of adding a character. When there is the operation of adding a character (S24: YES), the CPU 11 displays the added character with a first color (S25). The first color is determined according to the attributes of the text object 60. The first color is, for example, a print color of a label. S25 is an example of “character addition processing”.

When the added character is displayed with the first color, the CPU 11 determines whether the text object 60 being edited is switched from an active state to an inactive state (S26). When the text object 60 cannot be switched to the inactive state (S26: NO), the CPU 11 returns to S23 and waits for the next operation on the text object 60.

On the other hand, when another object is selected in the object selection field 53 of the editing screen 50, the CPU 11 switches the text object 60 being edited from the active state to the inactive state. In the text object 60 switched to the inactive state, the object frame 62 becomes hidden. For example, when receiving a print instruction or a save instruction via an operation button of the editing screen 50, the CPU 11 changes the state of the text object 60 from the active state to the inactive state.

When the text object 60 is switched to the inactive state (S26: YES), the CPU 11 returns to S21. Processing of S21 and thereafter will be described later.

When the editing operation for the selected text object 60 is not the operation of adding a character (S23: NO), the CPU 11 determines whether the editing operation for the selected text object 60 has an operation of changing the position or the size of the object frame 62 (S31). When there is the operation of changing the position or the size of the object frame 62 (S31: YES), the CPU 11 changes the position or the size of the text object 60 in response to the operation (S32).

For example, when a drag-and-drop operation is performed on the text object 60 using the operation unit 13b, the CPU 11 determines that there is the operation of changing the position of the object frame 62, and changes the position of the text object 60 from a drag start position to a drag end position, that is, a drop position.

For example, when a drag operation is performed on one of the four sides of the object frame 62 or on one of the four corners of the object frame 62 using the operation unit 13b, the CPU 11 determines that there is the operation of changing the size of the object frame 62, and changes the size of the corresponding text object 60.

The entirety of the object frame 62, the position or the size of which has been changed, may be present in the print guaranteed area 58b, or a part or entirety thereof may be present outside the print guaranteed area 58b. That is, the position or the size of the text object 60 can be changed to the outside of the print guaranteed area 58b. In this case, at least a part of the text object 60 is present in the area outside the print guaranteed area 58a. Further, the position or the size of the object frame 62 can be changed even if a character is not input in the text object 60.

When the position or the size of the text object 60 is changed, the CPU 11 executes character display processing (S33) and proceeds to S26. The character display processing is processing in which, when the character string 61 forming the text object 60 includes a character that does not fit in the print guaranteed area 58b, the character that does not fit therein is displayed with a color different from that of a character that fits in the print guaranteed area 58b. When the position or the size of the text object 60 is changed, characters forming the character string 61 may protrude from the print guaranteed area 58b. Accordingly, the label editing app 41 of the present embodiment executes the character display processing at a timing when the position or the size of the text object 60 is changed. The character display processing will be described later. The processing of S26 has been described above, so description thereof will be omitted.

When the editing operation for the selected text object 60 is not the operation of changing the position or the size of the object frame 62 (S31: NO), the CPU 11 determines whether the operation is an operation of changing the character size (S35). When there is the operation of changing the character size of the text object 60 (S35: YES), after changing the character size of the character string 61 (S36), the CPU 11 executes character display processing (S33) and proceeds to S26. The size of the text object 60 may be enlarged according to enlargement of the character size of the character string 61, and thus characters forming the character string 61 may protrude from the print guaranteed area 58b. Accordingly, the CPU 11 executes the character display processing at a timing when the character size of the text object 60 is changed. The character display processing will be described later.

When the editing operation for the selected text object 60 is not the operation of adding a character, the operation of changing the position or the size of the object frame 62, or the operation of changing the character size (S24: NO, S31: NO, and S35: NO), the CPU 11 executes another text editing processing (S37) and proceeds to S26. For example, when a font is changed in the object setting area 57, the CPU 11 displays the character string 61 with the changed font.

When the text object 60 is not selected (S21: NO), the CPU 11 determines whether there is another editing operation (S41). When there is the another editing operation, the CPU 11 performs processing corresponding to the editing operation (S42) and returns to S21. For example, when a two-dimensional code object is selected in the object selection field 53, the CPU 11 edits the two-dimensional code object in response to the operation of the operation unit 13b. Further, for example, when a tape to be used is changed in the label attribute setting area 52 of the editing screen 50 from a tape in which a rectangular label having rounded corners is attached to a mount to a tape in which a T-shaped label is attached to a mount, the CPU 11 sets the shape of the print guaranteed area 58b to a T-shape. At this time, the CPU 11 does not change the position or the size of the object. Further, for example, upon receiving a print instruction via the editing screen 50, the CPU 11 generates print data based on the edited image and transmits a print job including the generated print data to the label printer 3. Additionally, for example, upon receiving a save instruction via the editing screen 50, the CPU 11 generates a file that stores therein a content of the edited image and saves the file in a predetermined location.

When there is no another editing operation (S41: NO), the CPU 11 determines whether to end the label editing processing (S43). When an end button 54 of the editing screen 50 is not operated, the CPU 11 determines not to end the label editing processing. When the editing of the label is not ended (S43: NO), the CPU 11 returns to S21 and waits for the next operation. On the other hand, when the end button 54 is operated, the CPU 11 determines to end the label editing processing (S43: YES) and ends the label editing processing illustrated in FIG. 2.

### Fourth Embodiment

### Character Display Processing

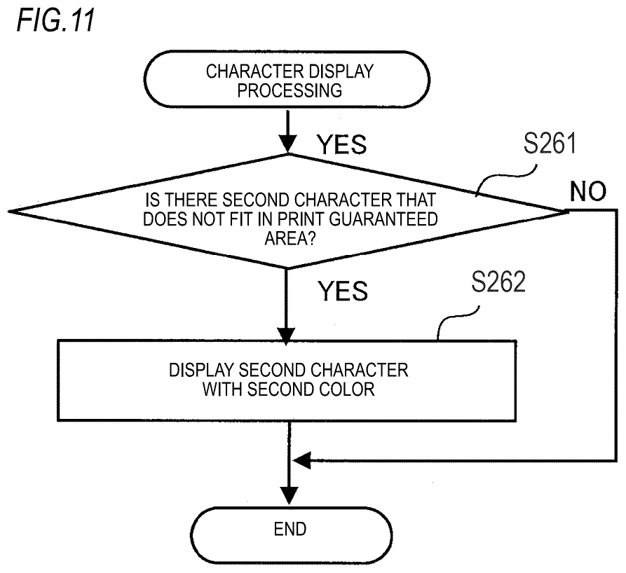

The above-mentioned character display processing will be described with reference to FIG. 11. When the position or the size of the text object 60 is changed, or when the character size of the text object 60 is changed, the CPU 11 executes the character display processing illustrated in FIG. 11 using the label editing app 41.

Specifically, the CPU 11 determines whether the character string 61 forming the text object 60 includes a second character that does not fit in the print guaranteed area 58b (S261). When there is the second character (S261: YES), the CPU 11 displays the second character with a second color (S262) and ends the character display processing. Desirably, the second color is a color different from a character color (a first color) of a first character that fits in the print guaranteed area 58b, a display color of the print guaranteed area 58b, that is, a base color of the label, and a display color of the area outside the print guaranteed area 58a. The reason for this is that, in this manner, the second character that does not fit in the print guaranteed area 58b is prominently displayed, thereby making it easier for the user to find the second character. Note that the CPU 11 does not change the display color of the first character that fits in the print guaranteed area 58b, and continues to display the first character with the first color.

Specifically, characters are designed within a reference frame set provided inside a square virtual body standardized by JIS standards. Both the virtual body and the reference frame are internal frames for disposing characters therein, and are not displayed on the editing screen 50 or printed on the label. The CPU 11 determines for each character whether the reference frame protrudes from the print guaranteed area 58b. The CPU 11 determines a character, the reference frame of which does not protrude from the print guaranteed area 58b, as the first character that fits in the print guaranteed area 58b. The CPU 11 determines a character, the reference frame of which partially or entirely protrudes from the print guaranteed area 58b, as the second character that does not fit in the print guaranteed area 58b.

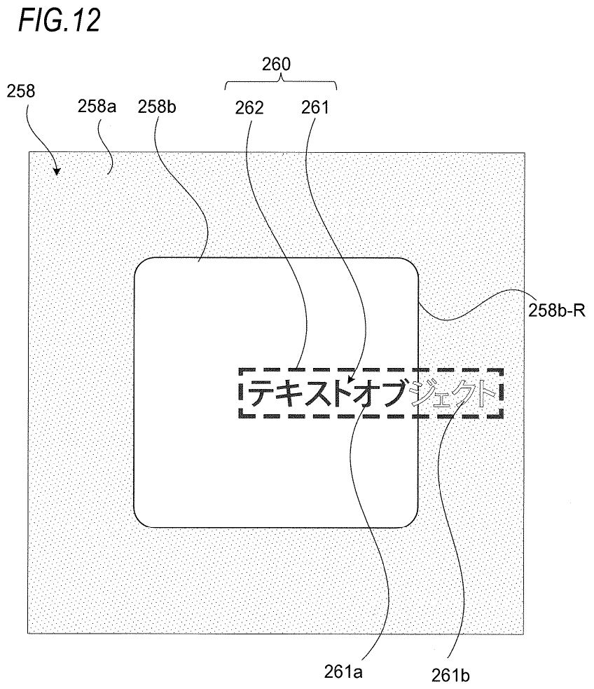

For example, when characters of a character string forming a text object are Japanese fonts such as kanji, hiragana, and katakana, each of the characters is designed based on a square reference frame. In a text object 260 illustrated in FIG. 12, among characters “ [symbol] [symbol] ” forming a character string 261, all the reference frames of the respective characters “ [symbol] ”, “ [symbol] ”, “ [symbol] ”, and “ [symbol] ” are disposed in a print guaranteed area 258b and therefore fit in the print guaranteed area 258b. A part of the reference frame of “ [symbol] ” is disposed in the print guaranteed area 258b, and a remaining portion thereof is disposed in an area outside the print guaranteed area 258a located outside a right end 258b-R in the drawing of the print guaranteed area 258b and does not fit in the print guaranteed area 258b. All the reference frames of the respective characters “ [symbol] ”, “ [symbol] ”, and “ [symbol] ” are disposed in the area outside the print guaranteed area 258a and do not fit in the print guaranteed area 258b. The CPU 11 changes the display color of “ [symbol] ”, “ [symbol] ”, “ [symbol] ”, and “ [symbol] ” from the first color to the second color as second characters 261b that do not fit in the print guaranteed area 258b. The CPU 11 continues to display “ [symbol] ”, “ [symbol] ”, “ [symbol] ”, and “ [symbol] ” as first characters 261a that fit in the print guaranteed area 258b with the first color. In other words, in the case of only part of the colored portion as well, any character protruding from the print guaranteed area 258b is considered the second character and is displayed with the second color.

For example, when characters in a character string forming a text object are Roman fonts such as the alphabet, the height within the reference frame varies depending on the characters. Roman font-based characters are designed based on five reference lines (an ascender line, a capital line, a mean line, a base line, and a descender line) provided in parallel with each other in order from the upper end of the reference frame. The five reference lines are internal reference lines for arranging characters, and are not displayed on the editing screen 50 or are not printed on the label. The reference frame is divided into first to fourth sections in order from the top according to five reference lines. The first section is a section between the ascender line and the capital line. The second section is a section between the capital line and the mean line. The third section is a section between the mean line and the base line. The fourth section is a section between the base line and the descender line. When the character string includes Roman font-based characters, the CPU 11 determines whether there is a section protruding from the print guaranteed area 258b among the first to fourth sections for the Roman font-based characters.

When determining whether a character in Roman font protrudes in the vertical direction of the print guaranteed area 258b, the CPU 11 determines whether, among the first to fourth sections of a character string, there is a section protruding outward from the print guaranteed area 258b. Then, when there is a protruding section, the CPU specifies, from characters forming a character string, a character having a portion to be colored in the section, sets the specified character as the second character, and changes a display color of the section from the first color to the second color.

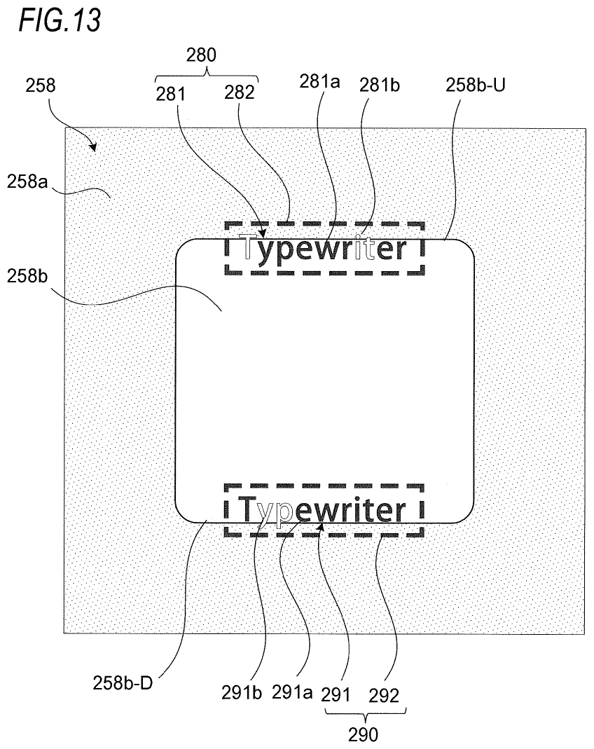

For example, a text object 280 illustrated in FIG. 13 is an example of a text object in which the individual characters of “Typewriter” are included in a character string 281, and the positions thereof have been moved toward an upper portion of an edited image display area 258. In the character string 281, the mean line is located at an upper end 258b-U of the print guaranteed area 258b, first and second sections protrude upward from the upper end 258b-U of the print guaranteed area 258b, and third and fourth sections are displayed in the edited image display area 258 in a state of fitting in the print guaranteed area 258b. Among the respective characters forming the character string 281, the upper ends of colored portions of the respective characters “T”, “i”, and “t” are located above the mean line and are disposed in the second section protruding upward from the upper end 258b-U of the print guaranteed area 258b, so that the characters are specified as second characters, and the display colors thereof are changed from the first color to the second color. On the other hand, the upper ends of colored portion of the respective characters “y”, “p”, “e”, “w”, “r”, “e”, and “r” are located below the mean line and are not disposed in the first and second sections protruding upward from the upper end 258b-U of the print guaranteed area 258b, so that the characters are not specified as the second characters and continue to be displayed with the first color.

For example, a text object 290 illustrated in FIG. 13 is an example of a text object in which the same characters “Typewriter” as the text object 280 are included in a character string 291, and the positions thereof have been moved toward a lower portion of the edited image display area 258. In the character string 291, the base line is located at a lower end 258b-D of the print guaranteed area 258b, a fourth section protrudes downward from the print guaranteed area 258b, and first to third sections are displayed in the edited image display area 258 in a state of fitting in the print guaranteed area 258b. Among the respective characters forming the character string 291, the lower ends of colored portions of the respective characters “y” and “p” are located below the base line and are disposed in the fourth section protruding downward from the lower end 258b-D of the print guaranteed area 258b, so that the CPU 11 specifies the characters as the second characters and changes the display colors thereof from the first color to the second color. On the other hand, the lower ends of colored portion of the respective characters “T”, “e”, “w”, “r”, “i”, “t”, “e”, and “r” are located above the base line and are not disposed in the fourth section protruding downward from the lower end 258b-D of the print guaranteed area 258b, so that the characters are not specified as the second characters and continue to be displayed with the first color.

When it is determined whether the Roman font-based characters included in the character strings 281 and 291 protrude from the left and right ends of the print guaranteed area 258b, determination is made based on whether the reference frames of the characters protrude outward from the print guaranteed area 258b without being based on the five reference lines.

Therefore, the presence of characters each displayed with the second color enables the user to easily grasp a text object protruding from the print guaranteed area 258b. Furthermore, a color displayed on the display 13a is changed on a character-by-character basis, thereby enabling the user to grasp, in a text object protruding from the print guaranteed area 258b, which character protrudes from the print guaranteed area 258b, and to perform correction.

As described above, the PC 1 executing the label editing app 41 of the fourth embodiment displays, at a timing when the position or the size of the object frame 262 is changed or at a timing when the character size is changed, the respective characters forming the character string 261 included in the text object 260 in such a manner that the second character 261b that does not fit in the print guaranteed area 258b is displayed with the second color different from the first color used to display the first character 261a that fits in the print guaranteed area 258b. Since the color of the second character 261b is changed, a character protruding from the print guaranteed area 258b is prominently displayed on the editing screen 50, thereby making it easier for the user to grasp which character of the text object 260 protrudes from the print guaranteed area 258b. Furthermore, since it is easy for the user to grasp how the character protrudes from the print guaranteed area 258b, it is also easier for the user to correct an object, the character of which protrudes from the print guaranteed area.

### Fifth Embodiment

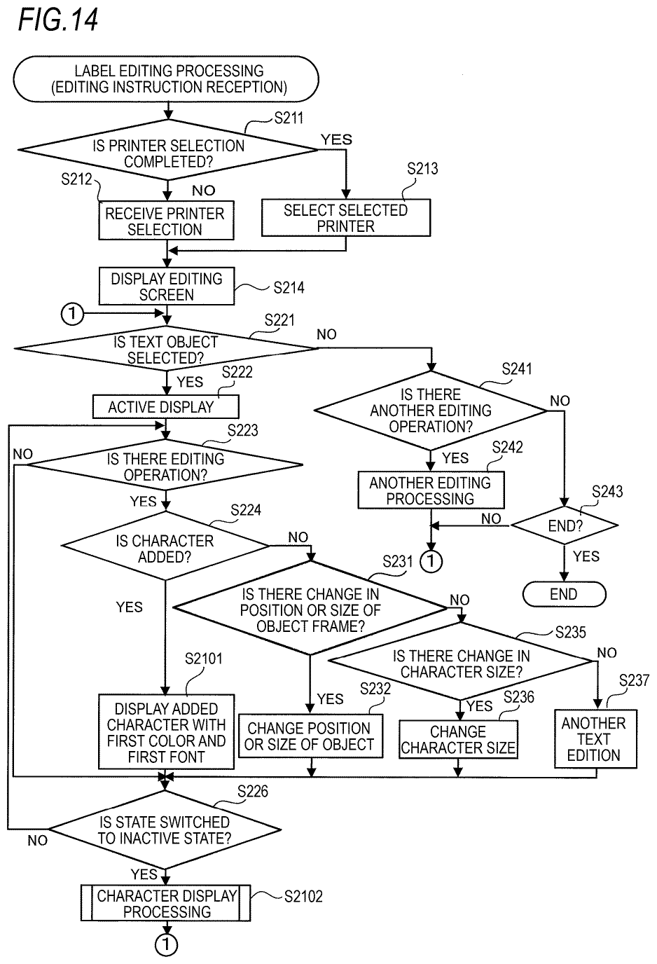

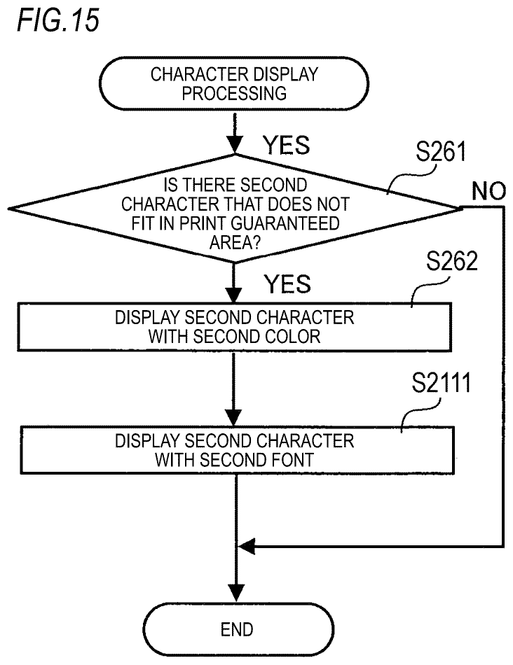

Next, the label editing app 41 of a fifth embodiment will be described. As illustrated in FIG. 14, the label editing app 41 of the fifth embodiment executes character display processing at a timing when an object is switched from an active state to an inactive state. This point is different from the fourth embodiment in which the character display processing is executed at a timing when the position or the size of the object is changed or at a timing when the character size is changed. Furthermore, as illustrated in FIG. 15, the label editing app 41 of the fifth embodiment changes a display color and a font for a character that does not fit in the print guaranteed area 258b. This point is different from the fourth embodiment in which, although the display color of a character that does not fit in the print guaranteed area 258b is changed, the font is not changed. In the fifth embodiment, only configuration and processing different from those of the fourth embodiment will be described, the same configuration and processing as those of the fourth embodiment will be denoted by the same reference numerals as those of the fourth embodiment, and redundant description thereof will be appropriately omitted.

As illustrated in FIG. 14, when a character is added to the text object 260 (S224), the CPU 11 displays the added character with a first color and a first font. The first color and the first font are predetermined or designated by the user. In other words, the first color and the first font are determined according to the attributes of the text object 260.

When the text object 260 being edited is switched to an inactive state (S226: YES), the CPU 11 executes character display processing (S2102). The character display processing of the fifth embodiment is processing of changing the display color and the font of a character protruding from the print guaranteed area 258b. Note that, in the fifth embodiment, the character display processing is not executed even if the position or the size of the text object 260 is changed (S231: YES, S232) or the character size of the character string 261 is changed. In order to further reduce a processing load on the PC 1 during editing of the character than a case in which the character display processing is executed each time the position or the size of the object frame 262 or the character size of the character string 261 is changed, in the fifth embodiment, the character display processing is executed at a timing when the text object 260 enters the inactive state. Note that, when the CPU 11 executes the character display processing each time the position or the size of the object frame 262 or the character size of the character string 261 is changed, the user can immediately grasp whether the position or the size of the text object 260 or the character size of the character string 261 is appropriate, as compared with a case in which the character display processing is executed at a timing when the object frame enters the inactive state.

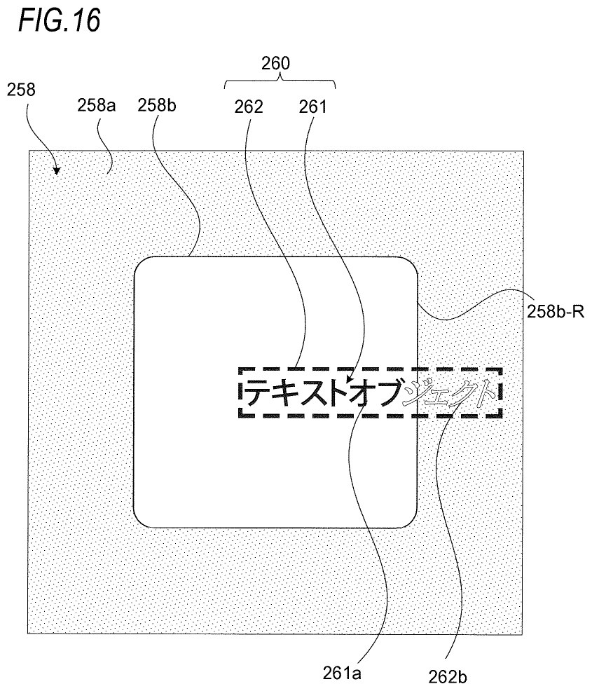

The character display processing of the fifth embodiment will be described. In the character display processing illustrated in FIG. 15, as illustrated in FIG. 16, the CPU 11 changes the character color of a character of the text object 260, which does not fit in the print guaranteed area 258b, from the first color to the second color (S262) and also changes the font from the first font to a second font (S2111). The font change may be a change, for example, to bold or italic, or may involve addition of character decoration such as an underline or a cancellation line.

As described above, the PC 1 executing the label editing app 41 of the fifth embodiment displays, at a timing when the text object enters the inactive state, the respective characters forming the character string 261 included in the text object 260 in such a manner that the second character 261b that does not fit in the print guaranteed area 258b is displayed with a color and a font different from those of the first character 261a that fits in the print guaranteed area 258b. Since the color and the font of the second character 261b are changed, a character protruding from the print guaranteed area 258b is prominently displayed on the editing screen 50, thereby making it easier for the user to grasp which character of the text object 260 protrudes from the print guaranteed area 258b. Furthermore, since it is easy for the user to grasp how the character protrudes from the print guaranteed area 258b, it is also easier for the user to correct an object, the character of which protrudes from the print guaranteed area.

Since the label editing app 41 of the fifth embodiment executes the character display processing and changes the display color of the second character that does not fit in the print guaranteed area 258b from the first color to the second color at a timing when the text object enters the inactive state, the processing load on the PC 1 is further reduced that a case in which the character display processing is executed each time the position or the size of the object frame 262 or the character size of the character string 261 is changed. However, when the PC 1 executes the character display processing each time the position or the size of the object frame 262 or the character size of the character string 261 is changed, it is easier for the user to appropriately grasp a text object protruding from the print guaranteed area 258b, as compared with a case in which the character display processing is executed at a timing when the text object enters the inactive state.

Note that the embodiments disclosed in the present specification are only examples and do not limit the present invention at all. Therefore, it is obvious that the technology disclosed in the present specification can be improved and modified in various ways without departing from the gist thereof.

For example, the second color used to display the second character in the character display processing of the fourth embodiment may be the same as either the color of the print guaranteed area 258b or the color of the area outside the print guaranteed area 258a. However, when the second color is the same as the color of the print guaranteed area 258b or the color of the area outside the print guaranteed area 258a, it becomes difficult to distinguish the second character from the print guaranteed area 258b or the area outside the print guaranteed area 258a. Therefore, by using the second color that is different from the first color, the color of the print guaranteed area 258b, and the color of the area outside the print guaranteed area 258a, the second character is displayed prominently on the editing screen 50 such that the user easily grasps the second character that does not fit in the print guaranteed area 258b.

For example, in the character display processing of the fourth embodiment, the display color of the second character may be changed to the second color, and the font of the second character may be changed. Furthermore, in the character display processing of the second embodiment, S262 in FIG. 11 may be omitted. That is, only the font of the second character may be changed. Since the color and the font of the second character are changed, the second character is displayed more prominently, as compared with a case in which only the color or the font of the second character is changed, thereby making it easier for the user to grasp the second character and correct the text object 260 including the second character.

For example, when the text object 260 that has entered the inactive state includes the second character 261b protruding from the print guaranteed area 258b, the object frame 262 may or may not be displayed. Even if the object frame 262 is not displayed, the second character 261b is displayed as a different character from the first character 261a, thereby enabling the user to notice the presence of the second character 261b. When the object frame 262 is displayed, the text object 260 including the second character 261b is prominently displayed, thereby making it easier for the user to notice the second character 261b.

For example, in the fourth embodiment, although the character display processing is executed at a timing when the position of the object frame 262 is changed, the size of the object frame 262 is changed, or the character size of the character string 261 is changed, the character display processing may be executed at only one of these timings. The character display processing is executed each time the position of the object frame 262 is changed, thereby enabling the user to appropriately grasp the second character that is not present in the print guaranteed area 258b in response to the change in position of the text object 260. The character display processing is executed each time the size of the object frame 262 is changed, thereby enabling the user to appropriately grasp the second character that is not present in the print guaranteed area 258b in response to the change in size of the text object 260. The character display processing is executed each time the character size of the character string 261 is changed, thereby enabling the user to appropriately grasp the second character that is not present in the print guaranteed area 258b in response to the change in character size.

For example, the character display processing of the fourth embodiment may be executed when the text object 260 enters the inactive state. For example, the character display processing of the fifth embodiment may be executed with at least one of a timing when the position of the object frame 262 is changed, a timing when the size of the object frame 262 is changed, and a timing when the character size of the character string 261 is changed.

For example, in the fourth embodiment, when the text object 260 is switched from the active state to the inactive state, the color of the second character protruding from the print guaranteed area 258b may return to the first color, or may continue to be the second color.

For example, the character display processing of the fourth and fifth embodiments may be executed when the tape information is changed in the label attribute setting area 52. For example, when the label shape is changed from a shape in which four rectangular corners are each formed to have a circular arc shape to a T-shape due to the change of the tape set in the label attribute setting area 52, the text object 260 disposed in the print guaranteed area 258b before the change may protrude from the changed T-shaped print guaranteed area. Therefore, the character change processing is executed when the tape information is changed in the label attribute setting area 52, thereby enabling the user to easily grasp the second character protruding from the changed print guaranteed area 258b.

The editing screen 50 illustrated in FIG. 3 includes a printer selection field 51, a label attribute setting area 52, an edited image display area 58, an object setting area 57, and various operation buttons.

The printer selection field 51 receives the selection of a printer to be controlled. When the printer selection field 51 is initially displayed, the label printer 3 selected in S12 or S13 is displayed in the printer selection field 51. The label attribute setting area 52 is an area in which settings related to attributes of a label are received. Attributes of a label include, for example, a width, a length, and a margin of the label. When the label attribute setting area 52 is initially displayed, tape information obtained from the printer selected in the printer selection field 51 is displayed for each item of the label attribute setting area 52. For example, tape information for a tape currently mounted in the selected printer is displayed in the label attribute setting area 52.

The edited image display area 58 displays an image which is being edited. The edited image display area 58 includes a print guaranteed area 58b and an area outside the print guaranteed area 58a. The print guaranteed area 58b is an area that virtually represents a label and is an area in which printing of an image is guaranteed. Meanwhile, the area outside the print guaranteed area 58a is an area that virtually represents the outside of the label and is an area in which an image cannot be printed on the label. In the initial display of the edited image display area 58, the print guaranteed area 58b is displayed based on the tape information set in the label attribute setting area 52. For example, in FIG. 3, the print guaranteed area 58b virtually illustrating the label in a case where a tape including a label, the square of which is cut into a circular shape, is set in the tape information of the label attribute setting area 52 is displayed in the edited image display area 58.

In order to enable the user to edit an image while visualizing a printed result, the print guaranteed area 58b of the edited image display area 58 is displayed with the same color as a base color (for example, white) of the label, and the area outside the print guaranteed area 58a is displayed with a color (for example, light gray) different from the base color of the label. The color of the area outside the print guaranteed area 58a is preferably different from the color of a content to be printed on the label so as to enable the user to grasp a content protruding from the print guaranteed area 58b. The color of the print guaranteed area 58b is an example of a “third color”, and the color of the area outside the print guaranteed area 58a is an example of a “fourth color”.

One or more objects can be disposed in the edited image display area 58. An object is formed of a rectangular object frame indicating an outline of the object and a content disposed inside the object frame. The position of the object can be changed by changing the position of the object frame by operation via the operation unit 13b. Further, the size of the object can be changed by changing the size of the object frame by operation via the operation unit 13b. A plurality of types of objects that can be disposed inside the edited image display area 58 are prepared in advance in the label editing app 41. The types of the object include, for example, a text object, a graphic object, and a two-dimensional code object. A character string, a graphic, and a two-dimensional code included in the respective objects of a text object, a graphic object, and a two-dimensional code object are examples of a “content”. Note that, although FIG. 3 illustrates an example of the editing screen 50 in a state in which a text object 60 is disposed in the edited image display area 58, no object is disposed in the print guaranteed area 58b in the initial display of the editing screen 50.

After setting the initial display of the editing screen 50, the CPU 11 determines whether an object has been selected (S21). Object types prepared in advance are displayed in an object selection field 53 and can be selected by the label editing app 41. The label editing app 41 can select an object to be disposed on the label via the object selection field 53.

For example, when the text object is selected in the object selection field 53 (S21: YES), the CPU 11 disposes the text object 60 in the edited image display area 58 in an active state (S22). An active state of an object is a state in which the object is editable. The object displayed in the edited image display area 58 can be switched between an active state and an inactive state by operation of the operation unit 13b. For example, the CPU 11 of the present embodiment disposes the text object 60 in the active state on the display 13a by displaying an object frame 62 of the text object 60, the content of which is a character string 61, in the print guaranteed area 58b. The object frame 62 of the initially displayed text object 60 is disposed in the print guaranteed area 58b so that all four sides 62a, 62b, 62c, and 62d fit in the print guaranteed area 58b.

In the text object 60 of the present embodiment, the background color of an area surrounded by the four sides 62a, 62b, 62c, and 62d of the object frame 62 is initially set to “100%” in transparency or to “none” in paint-out. As a result, in the text object 60, the color of the print guaranteed area 58b drawn on the back surface of the text object 60 and the color of the area outside the print guaranteed area 58a are displayed inside the object frame 62. The background color of the text object 60 can be changed by the user. The four sides 62a, 62b, 62c, and 62d of the object frame 62 are all displayed with a default color (for example, black). The object frame 62 may be displayed with a frame color designated by the user or with a frame color automatically selected by the label editing app 41.

A character string is not input in the initially displayed text object 60. Note that a character string as a sample may be input in advance in the text object 60. In response to the selection of the text object 60, the CPU 11 displays attributes and setting values that can be set for the text object 60 in the object setting area 57 of the editing screen 50. Attributes that can be set for the text object 60 include, for example, a font, a character size, a character color, a background color, and a character decoration (bold, italic, underline, and the like).

When the selected text object 60 is displayed in the active state, the CPU 11 determines whether there is an operation of editing the character string 61, which is the content of the text object 60 (S23). When there is the operation of editing the character string 61 (S23: YES), the CPU 11 edits the character string 61 based on an editing operation (S24). For example, upon receiving an operation of inputting the character string 61 using the operation unit 13b, the CPU 11 displays the input character string 61 inside the object frame 62. The character string 61 is displayed with a color to be printed on the label. Furthermore, for example, when the character size is changed in the object setting area 57, the CPU 11 changes the character size of the character string 61 displayed in the object frame 62 to the changed character size. After editing the character string 61, the CPU 11 returns to S23 and waits for the next operation on the text object 60.

When there is no operation of editing the character string 61 (S23: NO), the CPU 11 determines whether there is an operation of changing the position of the object frame 62 (S31). For example, when a drag-and-drop operation is performed on the text object 60 using the operation unit 13b, the CPU 11 determines that there is an operation of changing the position of the object frame 62.

When there is the operation of changing the position of the object frame 62 (S31: YES), the CPU 11 changes the position of the text object 60 including the character string 61 from a drag start position to a drag end position, that is, a drop position (S32). The entirety of the object frame 62, the position of which has been changed, may be present in the print guaranteed area 58b, or a part or entirety thereof may be present outside the print guaranteed area 58b. That is, the text object 60 can be moved to the outside of the print guaranteed area 58b. In this case, at least a part of the object frame 62 is present in the area outside the print guaranteed area 58a. Further, the position of the object frame 62 can be changed even if the character string 61 is not input in the text object 60.

When the position of the object frame 62 is changed, the CPU 11 executes frame display processing (S33). The frame display processing determines a display mode of the object frame 62 based on the object frame 62 and the print guaranteed area 58b, and displays the object frame 62 on the editing screen 50 in the determined display mode. The frame display processing will be described later. After executing the frame display processing, the CPU 11 returns to S23 and waits for the next operation on the text object 60.

When there is no operation of changing the position of the object frame 62 (S31: NO), the CPU 11 determines whether there is an operation of changing the size of the object frame 62 (S34). For example, when a drag operation is performed on one of the four sides 62a, 62b, 62c, and 62d of the object frame 62 or on one of the four corners of the object frame 62 using the operation unit 13b, the CPU 11 determines that there is an operation of changing the size of the object frame 62.

When there is the operation of changing the size of the object frame 62 (S34: YES), the CPU 11 changes the size of the corresponding text object 60 (S35). The entirety of the object frame 62, the size of which has been changed, may be present in the print guaranteed area 58b, or a part or entirety thereof may be present outside the print guaranteed area 58b. That is, the text object 60 may be expanded to the outside of the print guaranteed area 58b. In this case, at least a part of the object frame 62 is present in the area outside the print guaranteed area 58a. Further, the size of the object frame 62 can be changed even if the character string 61 is not input in the text object 60. After changing the size of the object frame 62, the CPU 11 displays the object frame 62 based on the frame display processing (S33). The frame display processing will be described later. After ending the frame display processing, the CPU 11 returns to S23 and waits for the next operation on the text object 60.

When there is no operation of changing the size of the object frame 62 (S34: NO), the CPU 11 determines whether the text object 60 being edited is switched from an active state to an inactive state (S36). When the text object 60 cannot be switched to the inactive state (S36: NO), the CPU 11 returns to S23 and waits for the next operation on the text object 60.

On the other hand, when another object is selected in the object selection field 53 of the editing screen 50, the CPU 11 switches the text object 60 being edited from the active state to the inactive state. In the text object 60 switched to the inactive state, the object frame 62 becomes hidden. For example, when receiving a print instruction or a save instruction via an operation button of the editing screen 50, the CPU 11 changes the state of the text object 60 from the active state to the inactive state.

When the text object 60 is switched to the inactive state (S36: YES), the CPU 11 returns to S21. For example, when a two-dimensional code object is selected in the object selection field 53 of the editing screen 50 (S21: YES), the CPU 11 executes processing of S22 and thereafter with respect to the selected two-dimensional code object.

For example, when there is no operation of selecting an object (S21: NO), the CPU 11 determines whether there is another editing operation (S41). When there is another editing operation (S41: YES), the CPU 11 executes the another editing processing (S42). For example, when a tape to be used is changed in the label attribute setting area 52 of the editing screen 50 from a tape in which a rectangular label having rounded corners is attached to a mount to a tape in which a T-shaped label is attached to a mount, the CPU 11 sets the shape of the print guaranteed area 58b to a T-shape. At this time, the CPU 11 does not change the position or the size of the object. Further, for example, upon receiving a print instruction via the editing screen 50, the CPU 11 generates print data based on the edited image and transmits a print job including the generated print data to the label printer 3. Additionally, for example, upon receiving a save instruction via the editing screen 50, the CPU 11 generates a file that stores therein a content of the edited image and saves the file in a predetermined location. When performing another editing operation, the CPU 11 returns to S21 and waits for the next operation.

When there is no another editing operation (S41: NO), the CPU 11 determines whether to end the label editing processing (S43). When an end button 54 of the editing screen 50 is not operated, the CPU 11 determines not to end the label editing processing. When the editing of the label is not ended (S43: NO), the CPU 11 returns to S21 and waits for the next operation. On the other hand, when the end button 54 is operated, the CPU 11 determines to end the label editing processing (S43: YES) and ends the label editing processing illustrated in FIG. 2.

### Sixth Embodiment

### Frame Display Processing

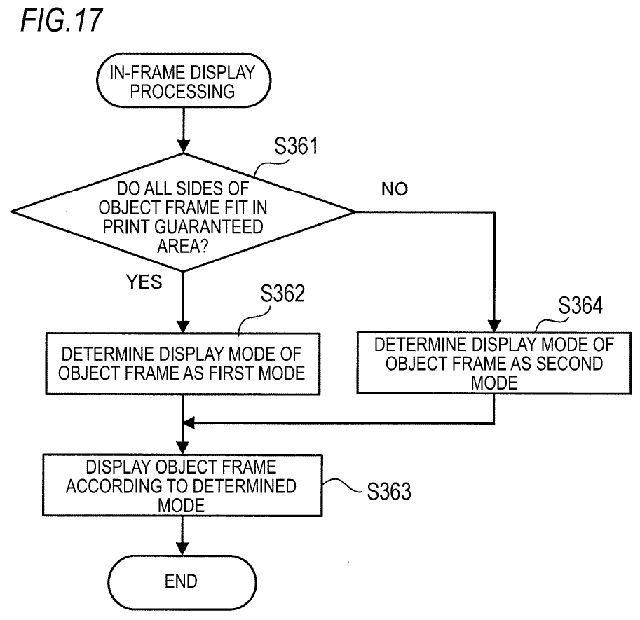

The above-mentioned frame display processing will be described with reference to FIG. 17. For example, when the position or the size of an object is changed, the CPU 11 executes the frame display processing illustrated in FIG. 17 using the label editing app 41. Here, as an example, a description will be given as to a case in which the position or the size of the text object 60 is changed.

Specifically, the CPU 11 determines whether all the four sides 62a, 62b, 62c, and 62d forming the object frame 62 fit in the print guaranteed area 58b (S361). For example, as illustrated in FIG. 3, when all the sides 62a, 62b, 62c, and 62d of the object frame 62 fit in the print guaranteed area 58b (S361: YES), the CPU 11 determines the display mode of the object frame 62 to be a first mode (S362) and displays the object frame 62 on the display 13a in accordance with the determined first mode (S63).

For example, the first mode is a mode in which all the four sides 62a, 62b, 62c, and 62d forming the object frame 62 are displayed with a first color. For example, the first color may be the same as the frame color before the position or size is changed or may be different from the frame color. In order to prominently display the object frame 62, desirably, the first color is a color different from the color of the print guaranteed area 58b, that is, the base color of the label, and the color of the area outside the print guaranteed area 58a, that is, the background color of the edited image display area 58. After displaying the object frame 62 in the first mode, the CPU 11 ends the frame display processing.

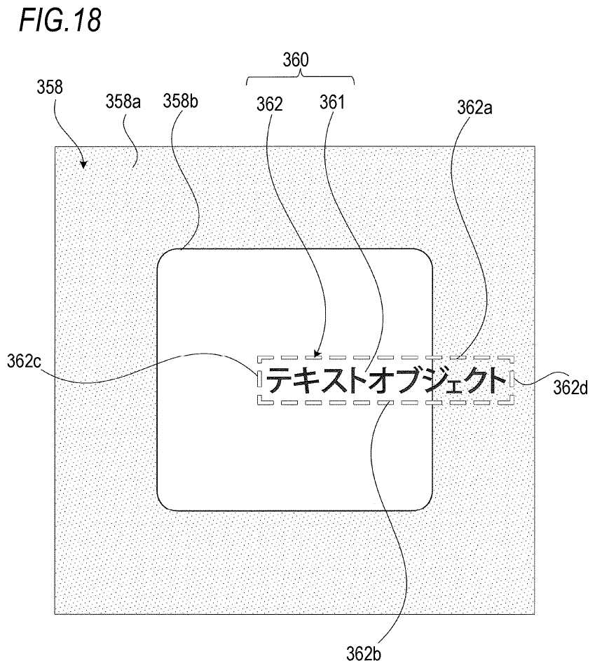

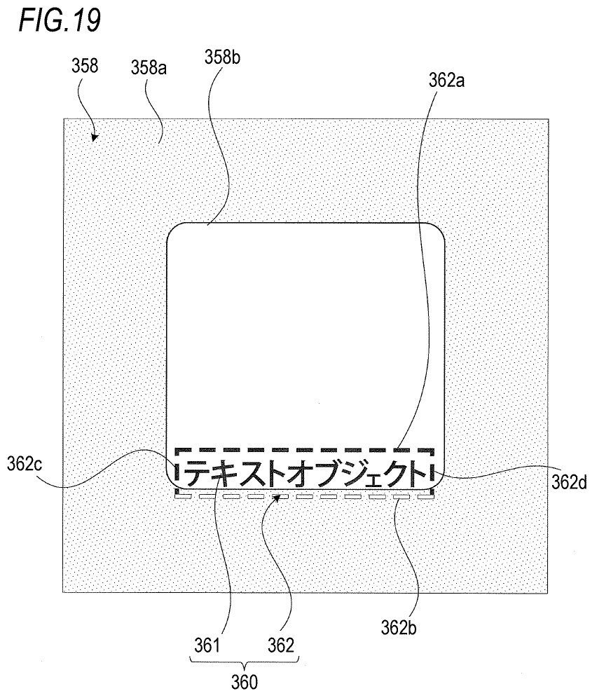

On the other hand, as illustrated in FIG. 18 or 19, when at least one (side 362d in FIG. 18 and side 362b in FIG. 19) of four sides 362a, 362b, 362c, and 362d forming an object frame 362 does not fit in a print guaranteed area 358b, the CPU 11 does not determine that all the sides 362a, 362b, 362c, and 362d of the object frame 362 fit in the print guaranteed area 358b. Upon not determining that all the sides 362a, 362b, 362c, and 362d fit in the print guaranteed area 358b (S361: NO), the CPU 11 determines the display mode of the object frame 362 to be a second mode (S364) and displays the object frame 362 on the display 13a in accordance with the determined second mode (S363).

For example, as illustrated in FIG. 18, the second mode may be a mode in which all the four sides 362a, 362b, 362c, and 362d forming the object frame 362 are displayed with a second color different from the first color. To clearly display the object frame 362 including the side 362d that does not fit in the print guaranteed area 358b and make it easier for the user to find the object frame 362, desirably, the second color is a color different from the first color, the color of the print guaranteed area 358b, that is, the base color of the label, and the color of the area outside the print guaranteed area 358a, that is, the background color of an edited image display area 358. Furthermore, for example, when the print color of a character string 361 is a single color, the second color is desirably different from the color of the character string 361. The reason for this is that, in this manner, it is easier for the user to distinguish between the character string 361 and the object frame 362.

For example, as illustrated in FIG. 19, the second mode may be a mode in which, among the four sides 362a, 362b, 362c, and 362d forming the object frame 362, the specific side 362b, which is a side that does not entirely fit in the print guaranteed area 358b, is displayed with the second color different from the first color, and the other sides 362a, 362c, and 362d are displayed with the first color. In this manner, the specific side 362b, the entirety of which does not fit in the print guaranteed area 358b, is displayed with a color different from the colors of the sides 362a, 362c, and 362d other than the specific side 362b, thereby making it easier for the user to grasp and correct the specific side 362b. After displaying the object frame 362 in the second mode, the CPU 11 ends the frame display processing.

Note that, in the frame display processing, since the display mode of the object frame 362 is determined based on the object frame 362 and the print guaranteed area 358b, even if the character string 361 (content) corresponding to a text object 360 (object) does not protrude from the print guaranteed area 358b, at least one side of the object frame 362 is changed to the second mode when the object frame 362 protrudes from the print guaranteed area 358b. In the case of the text object 360, when the number of characters is small, a margin is so long that it may be difficult for the user to notice the margin protruding from the print guaranteed area 358b. However, the label editing app 41 of the present embodiment prominently displays at least one side in the second mode when the object frame 362 of the text object 360 protrudes from the print guaranteed area 358b. As a result, it is possible to expect the user to correct the text object 360 such that the margin is reduced.

Furthermore, in the frame display processing, even if no character string 361 is input in the text object 360, the object frame 362 is displayed in the second mode when the object frame 362 protrudes from the print guaranteed area 358b. Therefore, when disposing a plurality of text objects, for example, the user can adjust the arrangement of the text object 360 before the character string 361 is input.

As described above, in the PC 1 executing the label editing app 41 of the sixth embodiment, at a timing when the position or the size of the object frame 362 is changed, when at least one of the four sides 362a, 362b, 362c, and 362d forming the object frame 362 having a rectangular shape does not fit in the print guaranteed area 358b, at least one of the four sides 362a, 362b, 362c, and 362d is displayed on the editing screen 50 in the second mode different from the first mode that is displayed when all the four sides 362a, 362b, 362c, and 362d fit in the print guaranteed area 358b. As a result, the object frame 362 that does not fit in the print guaranteed area 358b is prominently disposed on the editing screen 50, thereby making it easier to grasp an object protruding from the print guaranteed area 358b.

### Seventh Embodiment

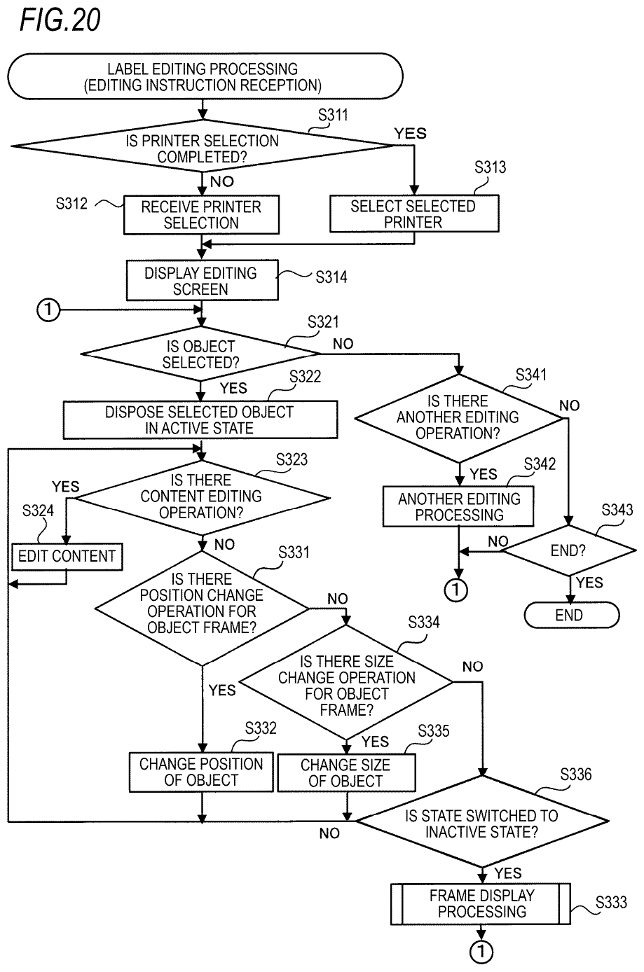

Next, a program of a seventh embodiment will be described with reference to FIG. 20. The label editing app 41 of the seventh embodiment executes frame display processing at a timing when an object is switched from an active state to an inactive state. This point is different from the sixth embodiment in which the frame display processing is executed at a timing when the position or the size of the object is changed. Furthermore, the label editing app 41 of the seventh embodiment has a function of displaying an object frame when an object to be disposed on a label is in an active state or when the object is in an inactive state. This point is different from the sixth embodiment in which the object frame 362 is not displayed when an object is in an inactive state. In the seventh embodiment, only configuration and processing different from those of the sixth embodiment will be described, the same configuration and processing as those of the sixth embodiment will be denoted by the same reference numerals as those of the sixth embodiment, and redundant description thereof will be appropriately omitted.

As illustrated in FIG. 20, for example, when the position or the size of the text object 360 is changed in response to a change in the position or the size of the object frame 362 (S332, S335), the CPU 11 returns to S323. That is, even if the object frame 362 protrudes from the print guaranteed area 358b due to a change in the position or the size thereof, the CPU 11 does not change the display of the object frame 362 to the display before the change.

When the text object 360 being edited is switched from an active state to an inactive state (S336: YES), the CPU 11 executes the frame display processing (S333) and returns to S321. For example, when another object is selected in a state in which the text object 360 is in the active state, the CPU 11 switches the text object 360 from the active state to the inactive state. The object frame 362 in the in active state is displayed on the editing screen 50 in the first mode when all the four sides 362a, 362b, 362c, and 362d fit in the print guaranteed area 358b, and is displayed on the editing screen 50 in the second mode when at least one of the four sides 362a, 362b, 362c, and 362d does not fits in the print guaranteed area 358b. Note that, when the text object 360, the object frame 362 of which is displayed in the second mode, is reselected and enters the active state, the object frame 362 is displayed in the first mode (S321: YES, S322).

In the label editing app 41, for example, even after a plurality of objects are disposed on a label, an object frame of each object is displayed in the first mode or the second mode. Therefore, the user easily grasps and corrects an object protruding from the print guaranteed area 358b from the display mode of the object frame of each object.

The PC 1 executing the label editing app 41 of the above-described seventh embodiment changes the display mode of the object frame 362 that does not fit in the print guaranteed area 358b at a timing when a text object enters the inactive state, or at a timing when the object is switched from the active state to the inactive state. Accordingly, the PC 1 further reduces a processing load generated when an object is edited, as compared with a case in which the display mode of the object frame 362 is determined each time an object is edited.

However, as in the sixth embodiment, the display mode of the object frame 362 protruding from the print guaranteed area 358b is changed at a timing when the position or the size of the object is changed, thereby enabling the user to immediately grasp whether the position or the size of the object is appropriate, as compared with a case in which the display mode of the object frame 362 is changed at a timing when the object enters the inactive state.

Note that the embodiments disclosed in the present specification are only examples and do not limit the present invention at all. Therefore, it is obvious that the technology disclosed in the present specification can be improved and modified in various ways without departing from the gist thereof.

For example, the first and second modes may be distinguished by a method other than the color of the object frame 362. For example, the first mode may be a mode of displaying the object frame 362 in a non-blinking state such as continuous lighting, and the second mode may be a mode of displaying the object frame 362 in a blinking state. In this manner, the object frame 362 that does not fit in the print guaranteed area 358b becomes the blinking state and stands out, thereby making it easier for the user to find an object that does not fit in the print guaranteed area 358b. The object frame 362 may be displayed with the same color in the non-blinking state and the blinking state, or may be displayed in different colors, as in FIGS. 18 and 19. The different display colors make the object frames 362 protruding from the print guaranteed area 358b even more prominent. For example, the line type of the object frame 362 may be different between the first mode and the second mode.

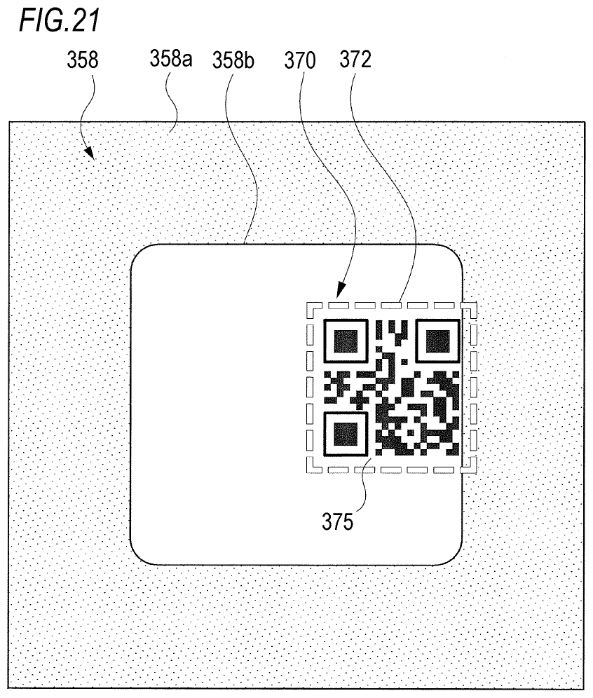

For example, an object, the object frame display mode of which is changed, may be an object other than the text object 360, such as a two-dimensional code object or a graphic object. Examples of the two-dimensional code include a barcode and a QR code (registered trademark). For example, as illustrated in FIG. 21, a two-dimensional code object 370 requires a margin 375 to distinguish the two-dimensional code object from other designs. When the margin 375 protrudes from the print guaranteed area 358b and the entirety of a two-dimensional code is not printed on the label, the two-dimensional code may not function as a two-dimensional code. For this reason, when an object frame 372 of the two-dimensional code object 370 protrudes from the print guaranteed area 358b, the label editing app 41 prominently displays the object frame 372 in the second mode, so that correction by the user can be expected.

For example, the second color may be the same as the color of the print guaranteed area 358b or the color of the area outside the print guaranteed area 358a. Here, since the second color is made different from the first color, the color of the print guaranteed area 358b, and the color of the area outside the print guaranteed area 358a, an object protruding from the print guaranteed area 358b is clearly displayed on the editing screen 50, thereby making it easier for the user to notice protrusion of the object.

For example, in the sixth embodiment, even if an object, the object frame of which protrudes from the print guaranteed area, enters the inactive state (S36: YES in FIG. 2), the object frame may not be erased while being displayed in the second mode. In this manner, in the object, the object frame is continuously displayed in the second mode as long as the object frame does not fit in the print guaranteed area, so that correction by the user can be expected.

For example, in the seventh embodiment, the frame display processing may be executed when the label attributes are changed in the label attribute setting area 52 of the editing screen 50. For example, a tape to be used is changed in the label attribute setting area 52 from a tape in which a rectangular label having rounded corners is attached to a mount to a tape in which a T-shaped label is attached to a mount, so that the shape of the print guaranteed area 358b is changed to a T-shape (S342 in FIG. 20). In this case, the object frame 362 of the text object 360, which fits in the print guaranteed area 358b before the change, may protrude from the T-shaped print guaranteed area after the change. Therefore, when the label attributes are changed, the frame display processing is executed to enable the object frame 362 protruding from the print guaranteed area 358b after the change to be prominently displayed in the second mode, so that correction by the user can be expected.

The object may include a first shape and a second shape. The first shape may be a first part of the object when the object fits in the print guaranteed area. The second shape may be a second part of the object when the object does not fit in the print guaranteed area. The second shape includes not displaying the second part of the object. The second shape includes blinking the all sides surround the second part of the object. The second shape includes changing font of the second part of the object different from font of the first part of the object.

Furthermore, in any of the flowcharts disclosed in the embodiments, the execution order of a plurality of processes in any plurality of steps can be arbitrarily changed within a range in which there is no conflict in processing contents, or the processes can be executed in parallel.

Further, the processing disclosed in the embodiments may be executed by a single CPU, a plurality of CPUs, hardware such as an ASIC, or a combination thereof. Additionally, the processing disclosed in the embodiments can be implemented in various modes such as a recording medium having recorded therein a program for executing the processing and a method.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a program causing an information processing apparatus to execute procedures comprising:
executing screen display processing of displaying, on a display of the information processing apparatus, an editing screen configured to receive editing of a label, the editing screen having displayed thereon a print guaranteed area of the label, wherein
the editing screen enables an object corresponding to a content to be disposed thereon, the object having an object frame indicating an outline of the object, the object frame having the content disposed therein, the object including the content being changeable in position by changing a position of the object frame through an operation via an input interface of the information processing apparatus, the object frame being movable toward an outside of the print guaranteed area,
the program further causes the information processing apparatus to execute, for the object disposed on the editing screen, display processing of:
displaying, on the display, the object with a first color when the object fits in the print guaranteed area; and
when at least a part of the object does not fit in the print guaranteed area,
displaying, on the display, the at least a part of the object with a second color,
displaying, on the display, the print guaranteed area on the editing screen with a third color, and
displaying, on the display, an area outside the print guaranteed area with a fourth color, wherein
the second color is a color different from the first color, the third color, and the fourth color, and
the third color and the fourth color are different colors.

2. The non-transitory computer readable storage medium according to claim 1, wherein the screen display processing executes, when an area present in the print guaranteed area is defined as a first area and an area outside the print guaranteed area is defined as a second area, in-frame display processing of:
displaying, on the display, a background of the first area with the first color; and
displaying, on the display, a background of the second area with the second color.

3. The non-transitory computer readable storage medium according to claim 1, wherein the screen display processing executes, for the object frame of the object disposed on the editing screen, in-frame display processing of:
displaying, when all four sides forming the object frame fit in the print guaranteed area, the four sides on the display with the first color; and
displaying, when at least one of the four sides does not fit in the print guaranteed area, the at least one of the four sides on the display with the second color.

4. The non-transitory computer readable storage medium according to claim 3, wherein the in-frame display processing is executed for the object frame of the object disposed on the editing screen such that
when all the four sides forming the object frame fit in the print guaranteed area, the four sides are displayed on the display with the first color, and when the at least one of the four sides does not fit in the print guaranteed area, all the four sides are displayed on the display with the second color.

5. The non-transitory computer readable storage medium according to claim 1, wherein, when an area present in the print guaranteed area is defined as a first area, and an area outside the print guaranteed area is defined as a second area,
the screen display processing executes, for each character forming a character string included in the text object disposed on the editing screen, character display processing of:
displaying a first character, which is a character that fits in the first area, on the display with the first color; and
displaying a second character, which is a character that does not fit in the first area, on the display with the second color.

6. The non-transitory computer readable storage medium according to claim 5, wherein, in the character display processing,
a font of the second character is changed to a font different from a font of the first character, and the second character is displayed on the display with the second color.

7. A non-transitory computer readable storage medium storing a program causing an information processing apparatus to execute procedures comprising:
executing screen display processing of displaying, on a display of the information processing apparatus, an editing screen configured to receive editing of a label, the editing screen having displayed thereon a print guaranteed area of the label, wherein
the editing screen enables an object corresponding to a content to be disposed thereon, the object having a rectangular object frame indicating an outline of the object, the object frame having the content disposed therein, the object including the content being changeable in position by changing a position of the object frame through an operation via an input interface of the information processing apparatus, the object frame being movable toward an outside of the print guaranteed area, and
the program further causes the information processing apparatus to execute, for the object disposed on the editing screen, display processing of:
displaying, on the display, the object in a first shape when the object fits in the print guaranteed area; and
displaying, on the display, at least a part of the object in a second shape different from the first shape when the at least a part of the object does not fit in the print guaranteed area.

8. The non-transitory computer readable storage medium according to claim 7, wherein the screen display processing executes content display processing of:
displaying, on the display, a first portion of the content disposed inside the object frame as the first shape, the first portion being present in the print guaranteed area, and
not displaying, on the display, a second portion of the content disposed inside the object frame as the second shape, the second portion not being present in the print guaranteed area.

9. The non-transitory computer readable storage medium according to claim 8, wherein the program causes the information processing apparatus to
execute, for the object frame of the object disposed on the editing screen, first object frame display processing of displaying, on the display, both a first frame portion that is present in the print-guaranteed area and a second frame portion that is not present in the print guaranteed area.

10. The non-transitory computer readable storage medium according to claim 8, wherein the information processing apparatus executes, for the object frame of the object disposed on the editing screen, second object frame display processing of:
displaying, on the display, a first frame portion that is present in the print guaranteed area; and
not displaying, on the display, a second frame portion that is not present in the print guaranteed area.

11. The non-transitory computer readable storage medium according to claim 7, wherein, in the screen display processing,
four sides are displayed on the display in a non-blinking state as the first shape, and
all the four sides are displayed on the display in a blinking state as the second shape.

12. The non-transitory computer readable storage medium according to claim 7, wherein the screen display processing executes, for each character forming a character string included in the text object disposed on the editing screen, character display processing of:
displaying, as the first shape, a first character, which is a character that fits in the print guaranteed area, on the display with a first font, and
displaying, as the second shape, a second character, which is a character that does not fit in the print guaranteed area, on the display with a second font different from the first font.

13. The non-transitory computer readable storage medium according to claim 1, wherein the program causes the information processing apparatus to
execute, in response to the object being switched from an active state in which the object is editable to an inactive state, the display processing through the operation via the input interface of the information processing apparatus.

14. The non-transitory computer readable storage medium according to claim 1, wherein the program causes the information processing apparatus to
execute, in response to a change in the position of the object disposed on the editing screen, the display processing through the operation via the input interface of the information processing apparatus.

15. The non-transitory computer readable storage medium according to claim 14, wherein the program causes the information processing apparatus to
execute, in response to a change in a size of the object disposed on the editing screen, in-frame display processing through the operation via the input interface of the information processing apparatus, and the size of the object is changeable by changing a size of the object frame through the operation via the input interface of the information processing apparatus.

16. The non-transitory computer readable storage medium according to claim 5, wherein the program causes the information processing apparatus to
execute the character display processing in response to a change in a character size set in the text object disposed on the editing screen.

17. The non-transitory computer readable storage medium according to claim 2, wherein the object is a text object having a character string as the content.

18. The non-transitory computer readable storage medium according to claim 2, wherein the object is a two-dimensional code object having a two-dimensional code as the content.

19. A method of displaying an editing screen executable by an information processing apparatus, the method causing the information processing apparatus to
execute screen display processing of displaying, on a display of the information processing apparatus, an editing screen configured to receive editing of a label, the editing screen having displayed thereon a print guaranteed area of the label, wherein
the editing screen enables an object corresponding to a content to be disposed thereon, the object having an object frame indicating an outline of the object, the object frame having the content disposed therein, the object including the content being changeable in position by changing a position of the object frame through an operation via an input interface of the information processing apparatus, the object frame being movable toward an outside of the print guaranteed area,
the program further causes the information processing apparatus to execute, for the object disposed on the editing screen, display processing of:
displaying, on a display, the object with a first color when the object fits in the print guaranteed area; and
when at least a part of the object does not fit in the print guaranteed area,
displaying, on the display, the at least a part of the object with a second color,
displaying, on the display, the print guaranteed area on the editing screen with a third color, and
displaying, on the display, an area outside the print guaranteed area with a fourth color, wherein
the second color is a color different from the first color, the third color, and the fourth color, and
the third color and the fourth color are different colors.
